(19) United States
(12) Patent Application Publication
(10) Pub. No.: US 2025/0063321 A1
(43) Pub. Date: Feb. 20, 2025

(54) INFORMATION PROCESSING DEVICE AND DATA STRUCTURE

(71) Applicant: Sony Group Corporation, Tokyo (JP)

(72) Inventors: Akihito Nakai, Kanagawa (JP); Toru Nakagawa, Chiba (JP); Masashi Fujihara, Kanagawa (JP)

(73) Assignee: Sony Group Corporation, Tokyo (JP)

(21) Appl. No.: 18/695,481

(22) PCT Filed: Sep. 22, 2022
(86) PCT No.: PCT/JP2022/035334

§ 371 Date: Oct. 30, 2024

(30) Foreign Application Priority Data
Oct. 6, 2021 (JP) 2021-164817

(51) Int. Cl. H04S 7/00

(52) U.S. Cl. CPC H04S 7/306

(57) ABSTRACT

The present technology relates to an information processing device and a data structure in which reproduction accuracy of a perceived sound can be improved.

The information processing device of the present technology includes a generation unit configured to generate a transfer characteristic file storing measurement data of transfer characteristics of a sound according to acoustic characteristics of a measurement space and condition information indicating a condition at a time of measuring the transfer characteristics. Furthermore, the information processing device of the present technology includes: a reproduction control unit configured to control reproduction of a sound by using measurement data acquired from a transfer characteristic file storing the measurement data of transfer characteristics of a sound according to acoustic characteristics of a measurement space and condition information indicating a condition at a time of measuring the transfer characteristics; and a presentation control unit configured to control presentation of information according to the condition information acquired from the transfer characteristic file. The present technology can be applied to, for example, a system that performs audio mixing of a movie.

### TECHNICAL FIELD

The present technology relates to an information processing device and a data structure, and particularly to an information processing device and a data structure in which reproduction accuracy of a perceived sound can be improved.

### BACKGROUND ART

By performing calculation using a head related transfer function (HRTF), it is possible to give a sense of direction and a sense of distance to the sound heard from headphones. For example, Patent Document 1 describes a technology for converting acoustic characteristics of an acoustic content into acoustic characteristics according to a place such as a movie theater by applying the HRTF.

By performing the calculation using a binaural room transfer function (BRTF) including the influence of reflection and diffraction occurring in a measurement space among the HRTFs, the sound heard from the headphones reproduces the direction and distance to the sound source in the measurement space.

### CITATION LIST

### Patent Document

Patent Document 1: WO 2020/189263

### Non Patent Document

Non Patent Document 1: Spatially Oriented Format for Acoustics (SOFA), [online], [retrieved on Jun. 22, 2021], Internet
   <URL:https://www.sofaconventions.org/mediawiki/index.php/SO FA_(Spatially_Oriented_Format_for_Acoustics)>

### SUMMARY OF THE INVENTION

### Problems to be Solved by the Invention

The positional relationship with the sound source reproduced using the BRTF depends on the position and posture of the measurement subject in the measurement space. For example, in a case where the field of view of the measurement subject at the time of measuring the BRTF is displayed as an image while the sound is output from the headphones, when the listener of the sound takes a posture different from the posture of the measurement subject at the time of the measuring, a discrepancy may occur between the positional relationship of the displayed sound source and the positional relationship of the sound source perceived with the sound heard from the headphones, and thus a sense of discomfort may occur.

Therefore, in order to improve the reproduction accuracy of the measurement space, detailed information regarding under what condition the BRTF measurement is performed is required.

The present technology has been made in view of such circumstances, and it is possible to improve the reproduction accuracy of the perceived sound.

### Solutions to Problems

According to a first aspect of the present technology, there is provided an information processing device including a generation unit configured to generate a transfer characteristic file storing measurement data of transfer characteristics of a sound according to acoustic characteristics of a measurement space and condition information indicating a condition at a time of measuring the transfer characteristics.

According to a second aspect of the present technology, there is provided an information processing device including: a reproduction control unit configured to control reproduction of a sound by using measurement data acquired from a transfer characteristic file storing the measurement data of transfer characteristics of a sound according to acoustic characteristics of a measurement space and condition information indicating a condition at a time of measuring the transfer characteristics; and a presentation control unit configured to control presentation of information according to the condition information acquired from the transfer characteristic file.

According to a third aspect of the present technology, there is provided a data structure including: measurement data of sound transfer characteristics of a sound according to acoustic characteristics of a measurement space; and condition information indicating a condition at a time of measuring the transfer characteristics, the information being used for presentation by an information processing device configured to reproduce a sound by using the measurement data.

In the first aspect of the present technology, a transfer characteristic file storing measurement data of transfer characteristics of a sound according to acoustic characteristics of a measurement space and condition information indicating a condition at a time of measuring the transfer characteristics is generated.

In the second aspect of the present technology, reproduction of a sound is controlled by using measurement data acquired from a transfer characteristic file storing the measurement data of transfer characteristics of a sound according to acoustic characteristics of a measurement space and condition information indicating a condition at a time of measuring the transfer characteristics, and presentation of information according to the condition information acquired from the transfer characteristic file is controlled.

In the third aspect of the present technology, there are included measurement data of sound transfer characteristics of a sound according to acoustic characteristics of a measurement space, and condition information indicating a condition at a time of measuring the transfer characteristics, the information being used for presentation by an information processing device configured to reproduce a sound by using the measurement data.

### BRIEF DESCRIPTION OF DRAWINGS

FIG. 1 is a diagram illustrating a configuration example of a sound production system according to an embodiment of the present technology.

FIG. 2 is a diagram illustrating a flow of measurement in a measurement environment.

FIG. 3 is a diagram illustrating an example of a method of acquiring measurement position information and measurement posture information.

FIG. 4 is a diagram illustrating an example of data stored in a BRTF file.

FIG. 5 is a diagram illustrating another example of data stored in a BRTF file.

FIG. 6 is a diagram illustrating a flow of reproduction in a reproduction environment.

FIG. 7 is a diagram illustrating an example of a shift of a sound image due to a difference between a posture at the time of reproduction and a measurement posture.

FIG. 8 is a block diagram illustrating a functional configuration example of an information processing device.

FIG. 9 is a block diagram illustrating a functional configuration example of a reproduction device.

FIG. 10 is a flowchart illustrating BRTF file generation processing performed by an information processing device.

FIG. 11 is a flowchart illustrating reproduction processing performed by a reproduction device.

FIG. 12 is a flowchart illustrating posture information display processing performed by a reproduction device.

FIG. 13 is a diagram illustrating a display example of a selection screen of a measurement posture.

FIG. 14 is a block diagram illustrating a functional configuration example of a reproduction device.

FIG. 15 is a flowchart illustrating reproduction processing performed by a reproduction device.

FIG. 16 is a block diagram illustrating a functional configuration example of a reproduction device.

FIG. 17 is a flowchart illustrating reproduction processing performed by a reproduction device.

FIG. 18 is a diagram illustrating a flow of display of a comparison result between a posture at a time of reproduction and a measurement posture.

FIG. 19 is a block diagram illustrating a functional configuration example of a reproduction device.

FIG. 20 is a flowchart illustrating posture information display processing performed by a reproduction device.

FIG. 21 is a diagram illustrating an example of a display screen of spatial information.

FIG. 22 is a diagram illustrating an example of a screen in a field of view of a measurement subject.

FIG. 23 is a block diagram illustrating a functional configuration example of a reproduction device.

FIG. 24 is a flowchart illustrating position information display processing performed by a reproduction device.

FIG. 25 is a block diagram illustrating a functional configuration example of a reproduction device.

FIG. 26 is a flowchart illustrating reproduction processing performed by a reproduction device.

FIG. 27 is a diagram illustrating an example of a reproduction environment.

FIG. 28 is a block diagram illustrating a functional configuration example of a reproduction device.

FIG. 29 is a flowchart illustrating reverberation adjustment processing performed by a reproduction device.

FIG. 30 is a block diagram illustrating a functional configuration example of a reproduction device.

FIG. 31 is a flowchart illustrating reproduction processing performed by a reproduction device.

FIG. 32 is a diagram illustrating an example of a method of managing BRTF measurement data.

FIG. 33 is a block diagram illustrating a configuration example of hardware of a computer.

### MODE FOR CARRYING OUT THE INVENTION

Hereinafter, a mode for carrying the present technology will be described. The description will be given in the following order.

1. Configuration of sound production system

2. Flow of entire processing

3. Configuration of each device

4. Operation of each device

5. Modification example

### 1. CONFIGURATION OF SOUND PRODUCTION SYSTEM

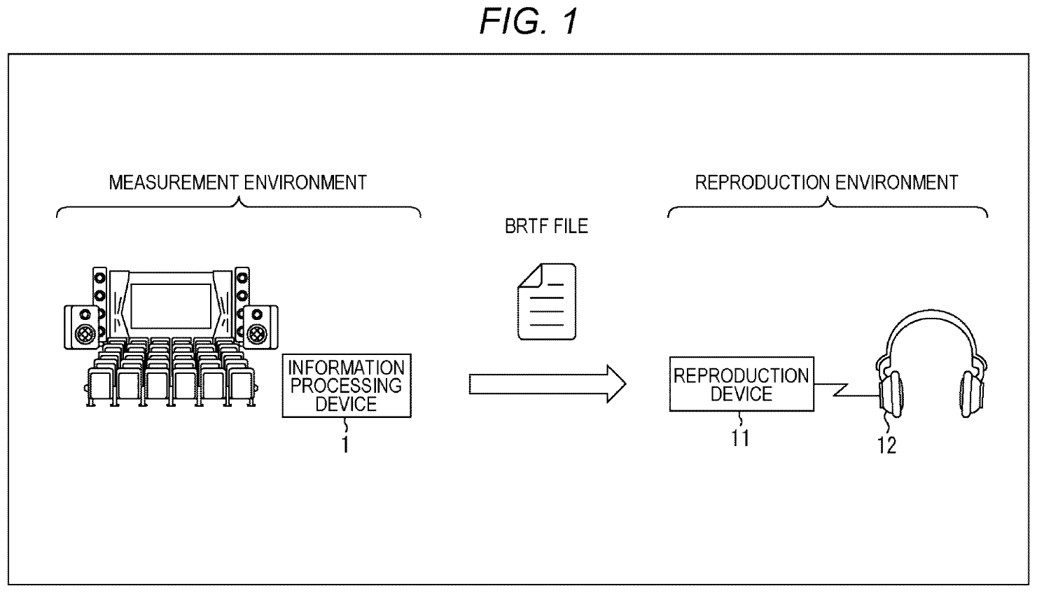

FIG. 1 is a diagram illustrating a configuration example of a sound production system according to an embodiment of the present technology.

The sound production system in FIG. 1 includes a device on a measurement environment side and a device on a reproduction environment side. The sound production system of FIG. 1 is, for example, a system used for producing a sound of a content such as a movie.

The sound of the movie includes not only the voice of a person such as a line or a narration of an actor but also various sounds such as a sound effect, an environmental sound, and BGM. Hereinafter, in a case where it is not necessary to distinguish the types of sounds, the sounds will be collectively described as a sound, but actually, the sounds of the movie include sounds of types other than the voice.

In the example of FIG. 1, a movie theater referred to as a dubbing stage or the like and used for sound production is a measurement space. In the movie theater, a plurality of speakers is provided together with a screen. Furthermore, the movie theater includes an information processing device 1 that acquires BRTF measurement data indicating transfer characteristics of a sound according to the acoustic characteristics of the measurement space and generates a BRTF file. The information processing device 1 includes, for example, a PC.

In the measurement environment, BRTF measurement is performed, and condition information indicating a condition at the time of BRTF measurement is acquired. Details of the condition information will be described later. By storing the condition information together with the BRTF measurement data indicating a result of the BRTF measurement, a BRTF file is generated by the information processing device 1.

As indicated by an arrow in FIG. 1, the BRTF file in which the BRTF data and the condition information are stored is provided to a reproduction device 11 provided in the reproduction environment. The BRTF file may be provided to the reproduction device 11 via a network such as the Internet or by using a recording medium such as a flash memory.

The reproduction environment is an environment in a place different from a movie theater, such as a studio or home of a producer. The reproduction environment may be prepared at the same place as the measurement environment.

In the reproduction environment, the reproduction device 11, which is a device used for editing such as mixing of the sounds of a movie, is provided. The reproduction device 11 includes, for example, a PC. The producer uses headphones 12 in the reproduction environment such as home to edit the sound of the movie. The headphones 12 is an output device prepared in the reproduction environment.

### 2. FLOW OF ENTIRE PROCESSING

The flow of processing performed in each of the measurement environment and the reproduction environment will be described.

### <Flow of Measurement in Measurement Environment>

### BRTF Measurement

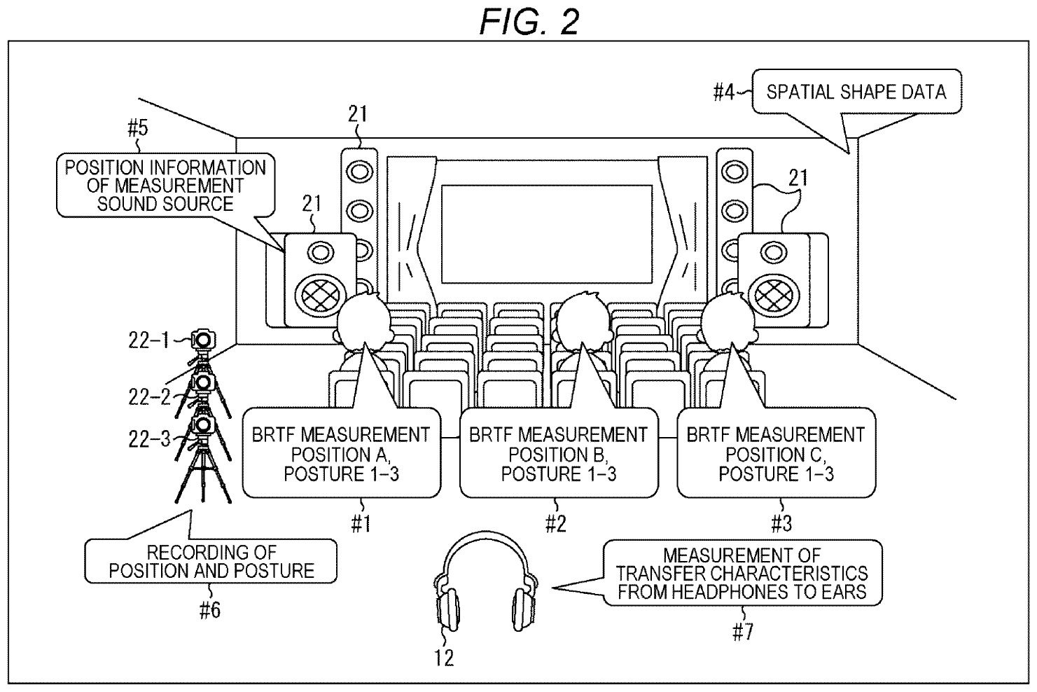

FIG. 2 is a diagram illustrating the flow of measurement in the measurement environment.

The BRTF measurement is performed in a state in which a measurement subject sits on a predetermined seat in a movie theater and wears a microphone attached to the ear hole. In this state, the reproduction sound is output from a speaker 21 of the movie theater, and the BRTF from the speaker 21 to the ears (for example, ear hole position, eardrum position) is measured.

For example, as illustrated in balloon #1 of FIG. 2, it is assumed that the BRTF measurement is performed in a state in which the measurement subject sits on a seat at a position A in postures 1 to 3. Furthermore, as illustrated in balloon #2, it is assumed that the BRTF measurement is performed in a state in which the measurement subject sits on a seat at a position B in postures 1 to 3. Moreover, it is assumed that the BRTF measurement is performed in a state in which the measurement subject sits on a seat at a position C in postures 1 to 3.

As illustrated in balloon #4, spatial shape data indicating the shape of the movie theater is acquired as condition information. For example, the width, height, and depth length of the movie theater are recorded as the spatial shape data as the smallest elements indicating the shape of the movie theater. Note that information indicating a more detailed shape such as vertex information and a point cloud may be recorded as the spatial shape data.

As illustrated in balloon #5, position information of speaker 21 that is a measurement sound source used for BRTF measurement is acquired as condition information. For example, coordinates indicating the position of the speaker 21 in the movie theater and a position on the spatial shape data of the movie theater corresponding to the origin of the coordinates are recorded as the position information of the speaker 21.

As illustrated in balloon #6, measurement position information indicating the position (measurement position) of the measurement subject at the time of measuring the BRTF and measurement posture information indicating the posture (measurement posture) are acquired as condition information. For example, coordinates indicating the position of the measurement subject in the movie theater and a position on the spatial shape data of the movie theater corresponding to the origin of the coordinates are recorded as the measurement position information. For example, the Euler angle of the head of the measurement subject is recorded as the measurement posture information.

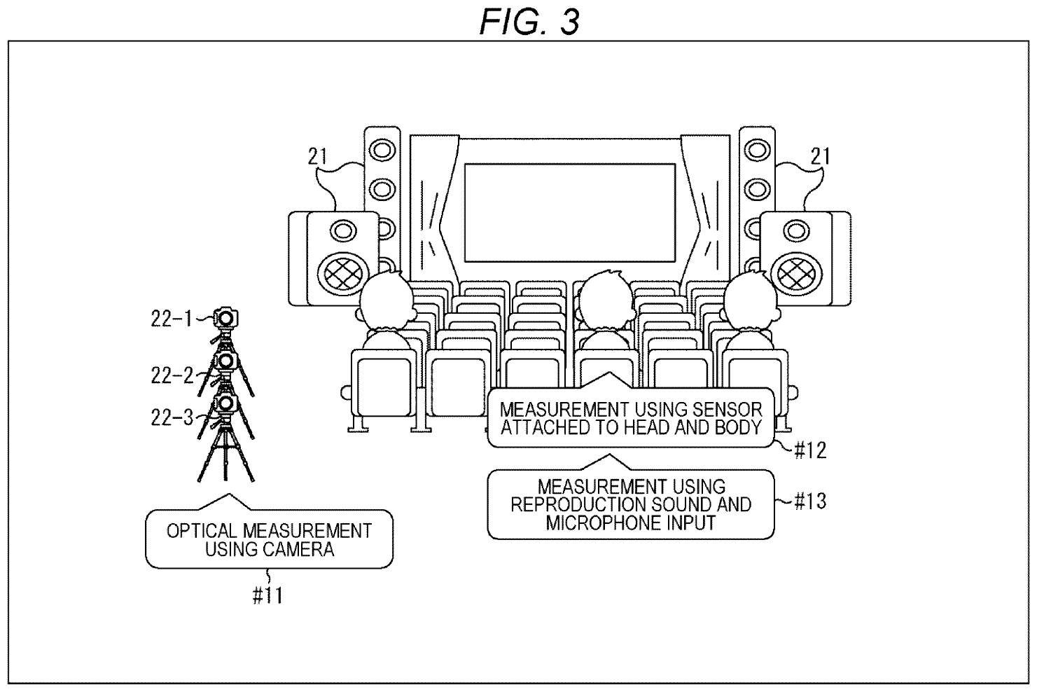

FIG. 3 is a diagram illustrating an example of a method of acquiring the measurement position information and the measurement posture information.

For example, as illustrated in balloon #11 of FIG. 3, the position of the measurement subject, the orientation of the head, and the orientation of the body are acquired by optical measurement using three cameras 22-1 to 22-3 provided in the movie theater.

Furthermore, for example, as illustrated in balloon #12, the position of the measurement subject, the orientation of the head, and the orientation of the body are acquired by measurement using a sensor attached to the head or the body of the measurement subject.

For example, as illustrated in balloon #13, the position of the measurement subject, the orientation of the head, and the orientation of the body are acquired by measurement using the input to the microphone attached to the ear hole of the measurement subject when the reproduction sound is output from the speaker 21.

Returning to FIG. 2, as illustrated in balloon #7, sound transfer characteristic data from the headphones 12 to the ears is acquired as the condition information. For example, after the BRTF measurement, the measurement subject wears the headphones 12 so as to cover the ears to which the microphone is attached. In this state, the reproduction sound is output from the headphones 12, and the transfer characteristics from the headphones 12 to the ears are measured. As the reproduction sound from the headphones 12, for example, the same sound as the reproduction sound output from the speaker 21 is used.

The transfer characteristic data from the headphones 12 to the ears is used for BRTF correction during the reproduction in the reproduction environment. This correction is performed such that an inverse of the transfer characteristics from the headphones 12 to the ears is superimposed on the BRTF from the speaker 21 to the ears, that is, the transfer characteristics from the headphones 12 to the ears are canceled.

By performing the BRTF correction, it is possible to obtain BRTF with high accuracy in consideration of individual differences of the headphones 12. Note that the transfer characteristic data from the headphones 12 to the ears may be acquired not in the measurement environment but in the reproduction environment or another environment.

### File Generation

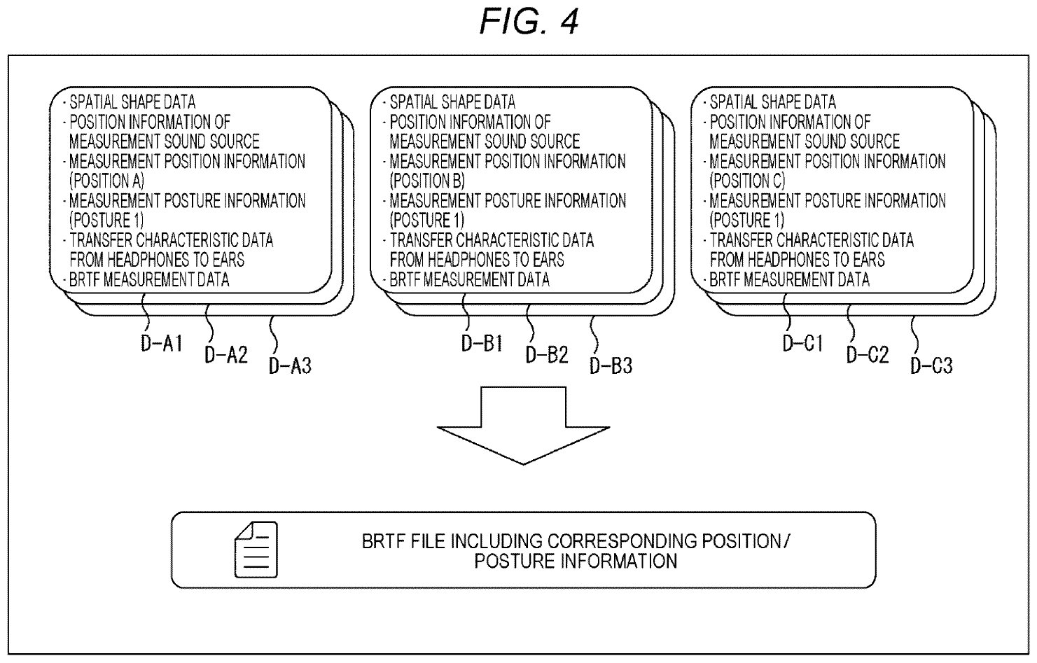

FIG. 4 is a diagram illustrating an example of data stored in the BRTF file.

As illustrated in FIG. 4, for example, data D-A1 to D-A3 corresponding to the combination of the position A and the postures 1 to 3, data D-B1 to D-B3 corresponding to the combination of the position B and the postures 1 to 3, and data D-C1 to D-C3 corresponding to the combination of the position C and the postures 1 to 3 are collectively stored, and thus the BRTF file including the corresponding position/posture information is generated.

In each of the data D-A1 to D-C3, the spatial shape data, the position information of the measurement sound source, the measurement position information, the measurement posture information, the transfer characteristic data from the headphones 12 to the ears, and the BRTF measurement data measured in a state in which the measurement subject sits on the seat at each position in each measurement posture are recorded in association with each other.

Note that, for example, in a case where BRTF measurement is performed a plurality of times in a state in which the measurement position and the measurement posture are different by using the measurement sound source at the same position in the same measurement space, the condition information indicating a condition common among the data D-A1 to D-C3 among the conditions at the time of measurement may be stored in the BRTF file as one piece of data.

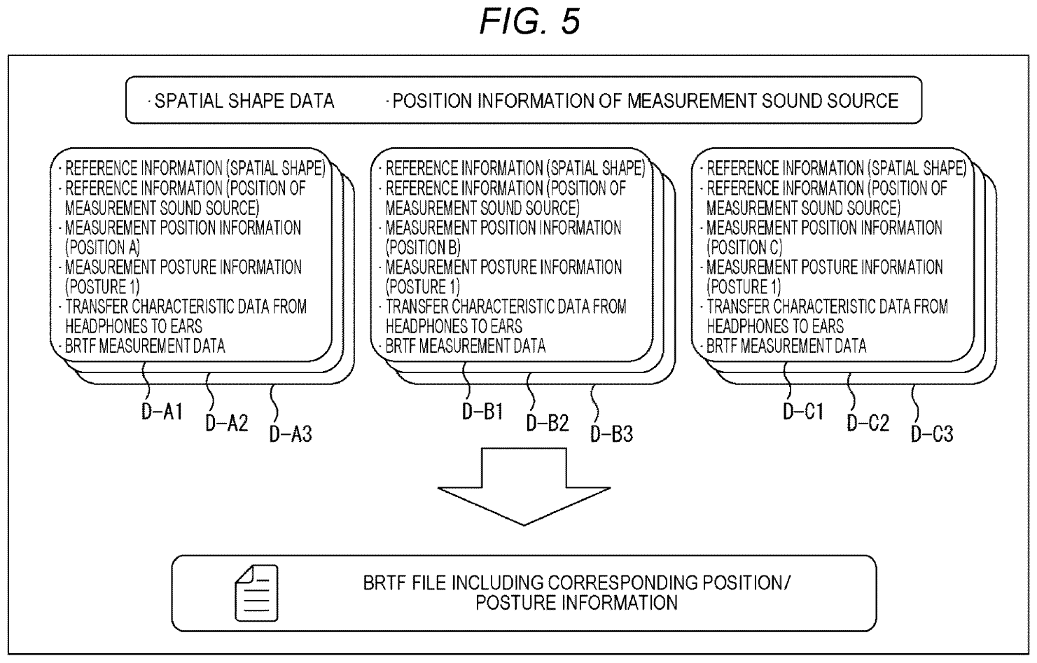

FIG. 5 is a diagram illustrating an example of the data stored in the BRTF file.

As illustrated in FIG. 5, for example, one piece of data in which the spatial shape data, which is the condition information indicating the condition common among the data D-A1 to D-C3, and the position information of the measurement sound source are recorded is stored in the BRTF file. In this case, each of the data D-A1 to D-C3 includes reference information for referring to the spatial shape data and reference information for referring to the position information of the measurement sound source.

### <Flow of Reproduction in Reproduction Environment>

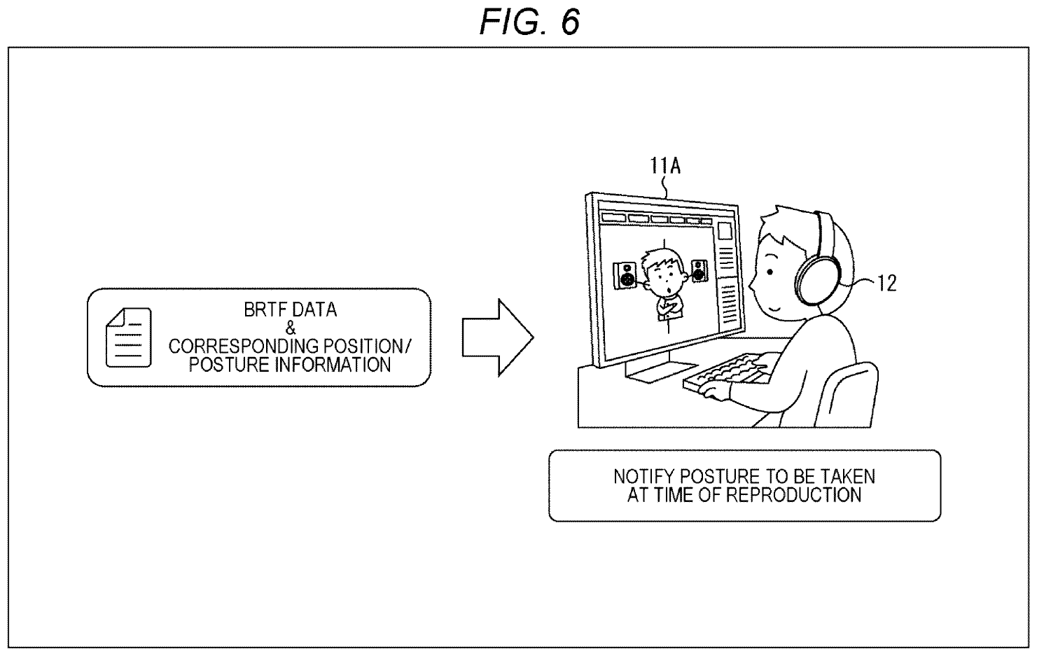

FIG. 6 is a diagram illustrating a flow of reproduction in the reproduction environment.

In the reproduction environment, the headphones 12 are connected to the reproduction device 11. For example, the headphones 12 taken home by the producer of the movie are used. The producer is a listener of the sound output from the headphones 12.

The reproduction device 11 reproduces the audio data of the movie to be edited, such as the object audio and the channel audio, by using the BRTF measurement data read from the BRTF file. The headphones 12 output the sound reproduced using the BRTF measurement data.

The producer can perform the editing work for the sound of the movie while listening to the reproduction sound output so as to reproduce the movie theater as a production environment of the sound of the movie.

The sound is output from the headphones 12, and information corresponding to the condition information read from the BRTF file is notified to the producer. In the example of FIG. 6, the producer is notified of the posture to be taken at the time of reproduction on the basis of the measurement posture information read from the BRTF file. For example, an image indicating a measurement posture at the time of the BRTF measurement is displayed on a display 11A.

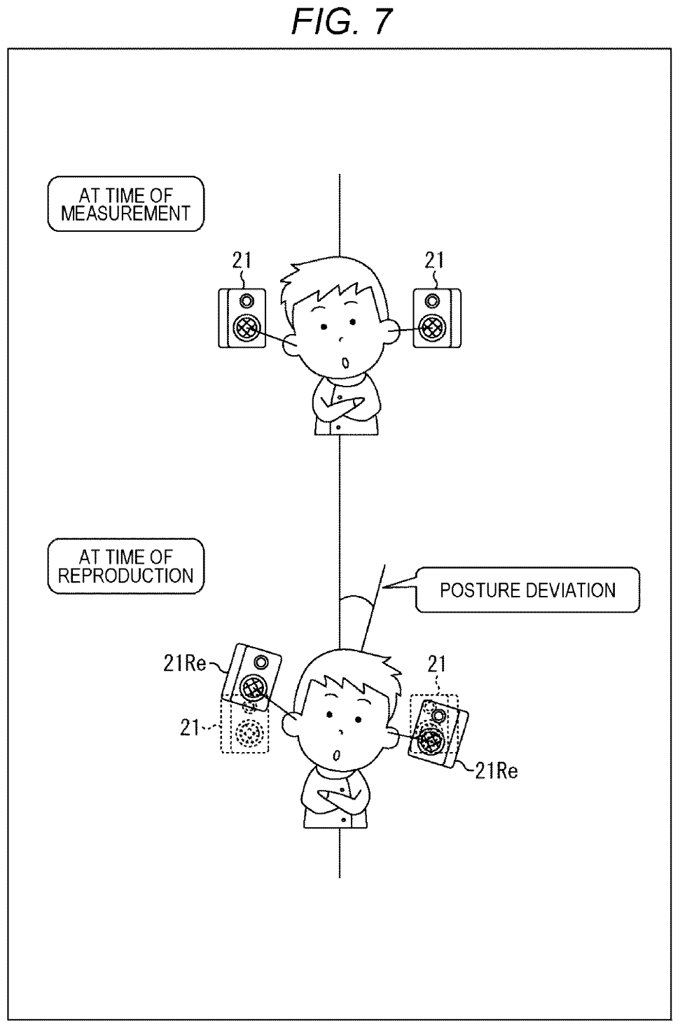

As illustrated in the upper side of FIG. 7, at the time of measurement, the BRTF that reproduces the positional relationship between the speaker 21 and the ears of the measurement subject according to the measurement posture of the measurement subject is measured.

As illustrated in the lower side of FIG. 7, at the time of reproduction, in a case where there is a deviation between the posture of the producer at the time of reproduction and the measurement posture of the measurement subject, the producer perceives that a sound is output from a speaker 21Re at a position deviated from the position of the speaker 21 in the measurement environment.

For example, in a case where the field of view of the measurement subject at the time of measurement is displayed as an image while the sound is output from the headphones 12, a discrepancy may occur between the positional relationship of the displayed speaker 21 and the positional relationship of the speaker 21 perceived with the sound heard from the headphones 12, and thus a sense of discomfort may occur.

In the present technology, since the measurement posture information indicating the measurement posture is stored in the BRTF file, the measurement posture can be presented to the producer on the basis of the measurement posture information. The producer can adjust his or her posture to match the presented measurement posture. By matching the posture of the producer at the time of reproduction with the measurement posture, it is possible to reduce the sense of discomfort occurring between the image of the field of view to be displayed and the sound heard from the headphones 12 and to prevent the sense of discomfort from occurring.

### 3. CONFIGURATION OF EACH DEVICE

### <Configuration of Information Processing Device>

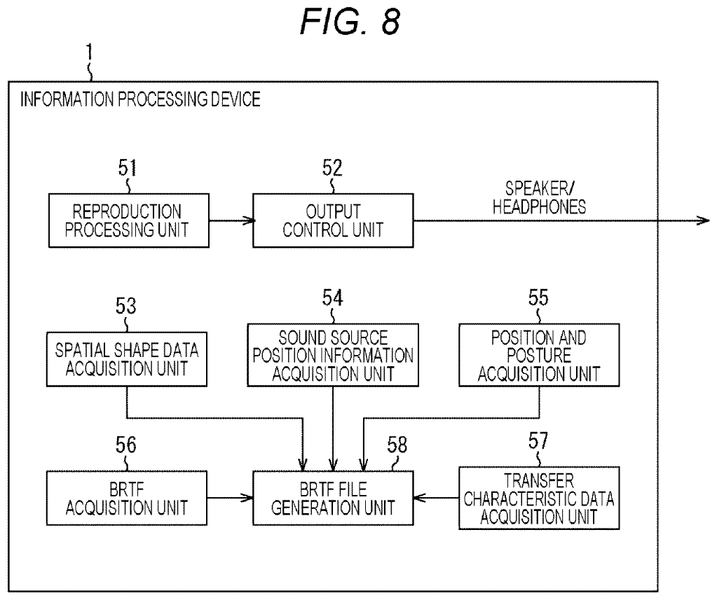

FIG. 8 is a block diagram illustrating a functional configuration example of the information processing device 1.

In the information processing device 1, each functional unit illustrated in FIG. 8 is realized by a CPU of a PC constituting the information processing device 1 executing a predetermined program.

As illustrated in FIG. 8, the information processing device 1 includes a reproduction processing unit 51, an output control unit 52, a spatial shape data acquisition unit 53, a sound source position information acquisition unit 54, a position and posture acquisition unit 55, a BRTF acquisition unit 56, a transfer characteristic data acquisition unit 57, and a BRTF file generation unit 58.

The reproduction processing unit 51 controls reproduction of the sound to be output from the headphones 12 and the speaker 21. A sound signal obtained by reproducing the audio data for measurement is supplied to the output control unit 52.

The output control unit 52 causes the reproduction sound corresponding to the sound signal supplied from the reproduction processing unit 51 to be output from the headphones 12 and the speaker 21.

The spatial shape data acquisition unit 53 acquires spatial shape data indicating the shape of the measurement space, and supplies the spatial shape data to the BRTF file generation unit 58.

The sound source position information acquisition unit 54 acquires the position information of the measurement sound source and supplies the position information to the BRTF file generation unit 58.

The position and posture acquisition unit 55 acquires the measurement position information and the measurement posture information by, for example, optical measurement using the cameras 22-1 to 22-3, and supplies the measurement position information and the measurement posture information to the BRTF file generation unit 58.

The BRTF acquisition unit 56 acquires the BRTF measurement data from the speaker 21 to the ears on the basis of a sound collection result by the microphone, and supplies the BRTF measurement data to the BRTF file generation unit 58. For example, the BRTF measurement data is recorded in form of a Binaural Room Impulse Response (BRIR) which is time domain information indicating transfer characteristics of a sound according to the acoustic characteristics of the measurement environment.

The transfer characteristic data acquisition unit 57 acquires the transfer characteristic data from the headphones 12 to the ears on the basis of the sound collection result by the microphone, and supplies the transfer characteristic data to the BRTF file generation unit 58.

The BRTF file generation unit 58 generates a BRTF file storing the spatial shape data, the position information of the measurement sound source, the measurement position information, the measurement posture information, the BRTF measurement data from the speaker 21 to the ears, and the transfer characteristic data from the headphones 12 to the ears.

### <Configuration of Reproduction Device>

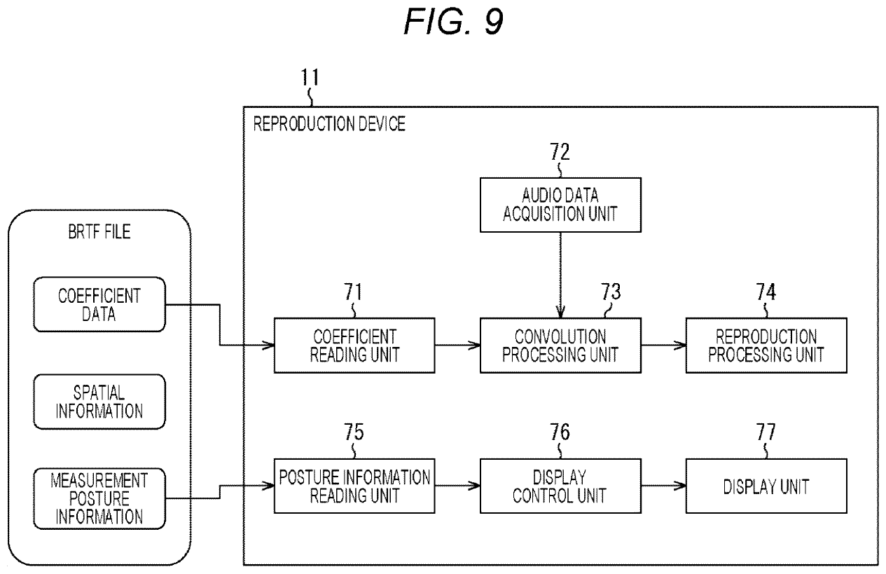

FIG. 9 is a block diagram illustrating a functional configuration example of the reproduction device 11.

In the reproduction device 11, each functional unit illustrated in FIG. 9 (excluding a display unit 77) is realized by the CPU of the PC constituting the reproduction device 11 executing a predetermined program.

As illustrated in FIG. 9, the reproduction device 11 includes a coefficient reading unit 71, an audio data acquisition unit 72, a convolution processing unit 73, a reproduction processing unit 74, a posture information reading unit 75, a display control unit 76, and a display unit 77.

The coefficient reading unit 71 reads the BRTF measurement data from the BRTF file as coefficient data of a finite impulse response (FIR) filter, corrects the BRTF measurement data by using the transfer characteristic data from the headphones 12 to the ears, and supplies the corrected data to the convolution processing unit 73.

The audio data acquisition unit 72 acquires audio data such as a sound signal of a movie and supplies the audio data to the convolution processing unit 73.

The convolution processing unit 73 performs convolution processing of the FIR filter on the sound signal supplied from the audio data acquisition unit 72 by using the coefficient data supplied from the coefficient reading unit 71, and generates a reproduction signal. The reproduction signal generated by the convolution processing unit 73 is supplied to the reproduction processing unit 74.

The reproduction processing unit 74 performs acoustic processing such as 2-ch mixing processing, sound quality adjustment, and gain adjustment on the reproduction signal supplied from the convolution processing unit 73, and outputs the reproduction signal obtained by performing the acoustic processing. For example, the reproduction signal for L and the reproduction signal for R output from the reproduction processing unit 74 are supplied to the headphones 12. The headphones 12 output a reproduction sound corresponding to the reproduction signal.

The posture information reading unit 75 reads the measurement posture information from the BRTF file and supplies the measurement posture information to the display control unit 76.

The display control unit 76 causes the display unit 77 to display the measurement posture information supplied from the posture information reading unit 75.

The display unit 77 is configured by a display, a head-mounted display, or the like. The display unit 77 displays the measurement posture information under the control of the display control unit 76. The display unit 77 corresponds to the display 11A of FIG. 6.

### 4. OPERATION OF EACH DEVICE

Here, processing of each device of the sound production system having the above-described configuration will be described.

### <Operation of Information Processing Device>

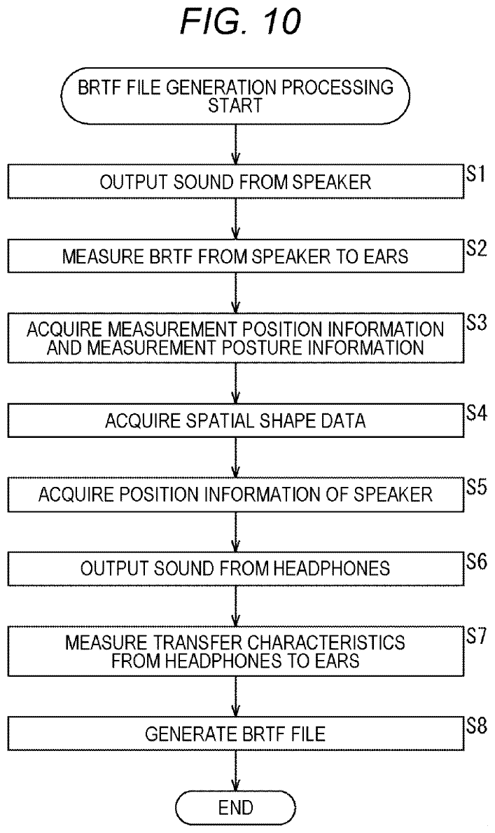

The BRTF file generation processing performed by the information processing device 1 will be described with reference to a flowchart of FIG. 10.

Here, processing of all steps in FIG. 10 will be described as processing performed by the information processing device 1, but is appropriately performed by other devices prepared in the measurement environment. As described above, the BRTF measurement is performed in a state in which the measurement subject sits on a predetermined seat in a movie theater and wears a microphone attached to the ear hole.

In step S1, the output control unit 52 causes the speaker 21 in the movie theater to output the reproduction sound.

In step S2, the BRTF acquisition unit 56 measures BRTF from the speaker 21 to the ears on the basis of the sound collection result by the microphone. After the BRTF measurement from the speaker 21 to the ears is performed, the measurement subject wears the headphones 12 so as to cover the ears to which the microphone is attached.

In step S3, the position and posture acquisition unit 55 acquires the measurement position information and the measurement posture information.

In step S4, the spatial shape data acquisition unit 53 acquires spatial shape data of the movie theater.

In step S5, the sound source position information acquisition unit 54 acquires the position information of the speaker 21 as the measurement sound source.

In step S6, the output control unit 52 causes the headphones 12 worn by the measurement subject to output the reproduction sound.

In step S7, the transfer characteristic data acquisition unit 57 measures the transfer characteristics from the headphones 12 to the ears on the basis of the sound collection result by the microphone.

In step S8, the BRTF file generation unit 58 generates the BRTF file storing the BRTF measurement data from the speaker 21 to the ears, the measurement position information, the measurement posture information, the spatial shape data, the position information of the speaker 21, and the transfer characteristic data from the headphones 12 to the ears.

### <Operation of Reproduction Device>

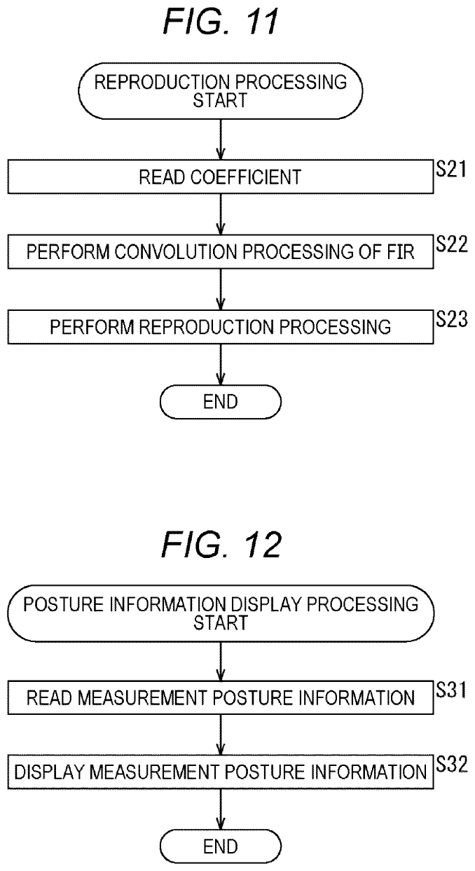

The reproduction processing performed by the reproduction device 11 will be described with reference to a flowchart of FIG. 11. For example, the reproduction processing of FIG. 11 is started in a state in which the audio data is acquired in advance by the audio data acquisition unit 72.

In step S21, the coefficient reading unit 71 reads coefficient data from the BRTF file.

In step S22, the convolution processing unit 73 performs convolution processing of the FIR filter by using the coefficient data to generate a reproduction signal.

In step S23, the reproduction processing unit 74 performs reproduction processing. For example, the reproduction processing unit 74 performs acoustic processing on the reproduction signal and outputs the reproduction signal obtained by performing the acoustic processing from the headphones 12.

The posture information display processing performed by the reproduction device 11 will be described with reference to a flowchart of FIG. 12. For example, the posture information display processing of FIG. 12 is performed in parallel with the reproduction processing of FIG. 11.

In step S31, the posture information reading unit 75 reads the measurement posture information from the BRTF file.

In step S32, the display control unit 76 causes the display unit 77 to displays the measurement posture information.

As described above, the producer of the sound of the movie can confirm the posture of the measurement subject at the time of the BRTF measurement. when the producer takes the posture at the time of reproduction so as to match the posture of the measurement subject at the time of the measurement, it is possible to improve the reproduction accuracy of the sound in the measurement environment perceived by the producer.

### 5. MODIFICATION EXAMPLE

### <Example of Selecting Measurement Posture>

In the reproduction environment, a plurality of the measurement postures may be presented to the producer such that the producer can select a desired measurement posture.

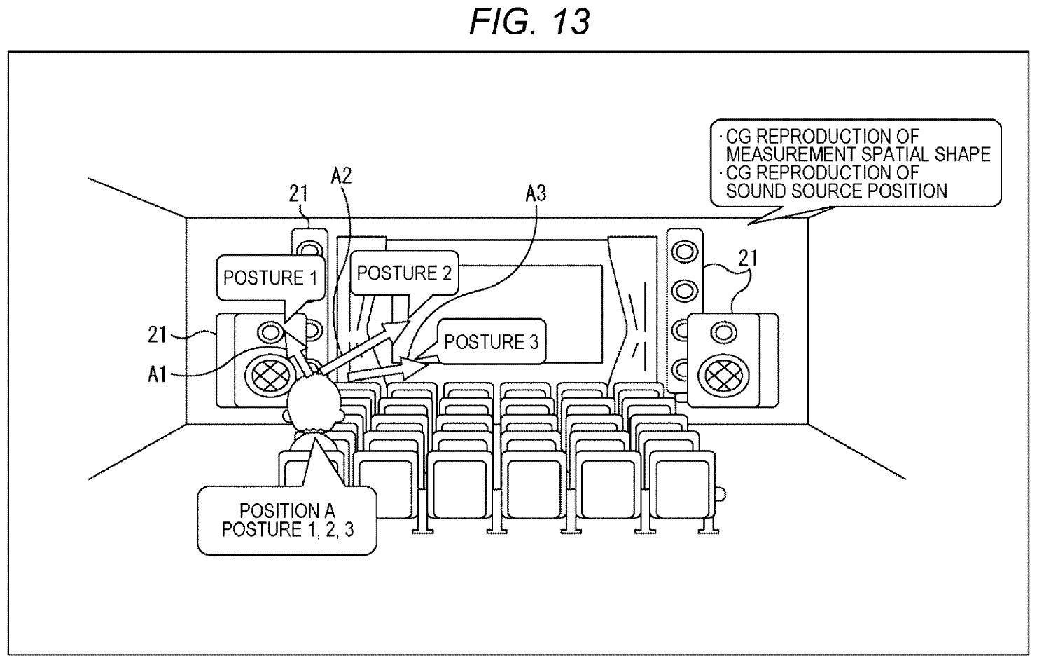

FIG. 13 is a diagram illustrating a display example of a selection screen of the measurement posture.

As illustrated in FIG. 13, in the measurement environment, in a case where the BRTF measurement is performed in a state in which the measurement subject sits on the seat at the position A in the postures 1 to 3, an image indicating the measurement subject sitting at the position A and arrows A1 to A3 indicating the directions of the line-of-sight of the measurement subject are displayed on the selection screen. In the example of FIG. 13, the measurement posture of the measurement subject is indicated by the direction of the line-of-sight of the measurement subject. Note that, on the selection screen, the shape of the movie theater as the measurement space and the speaker 21 as the measurement sound source may be reproduced using computer graphics (CG).

The producer can select the measurement posture by selecting any one of the arrows A1 to A3. The sound reproduced using the BRTF measurement data associated with the measurement posture selected by the producer is output from the headphones 12. Note that the balloon in the drawing is illustrated for convenience of description, and is not actually displayed.

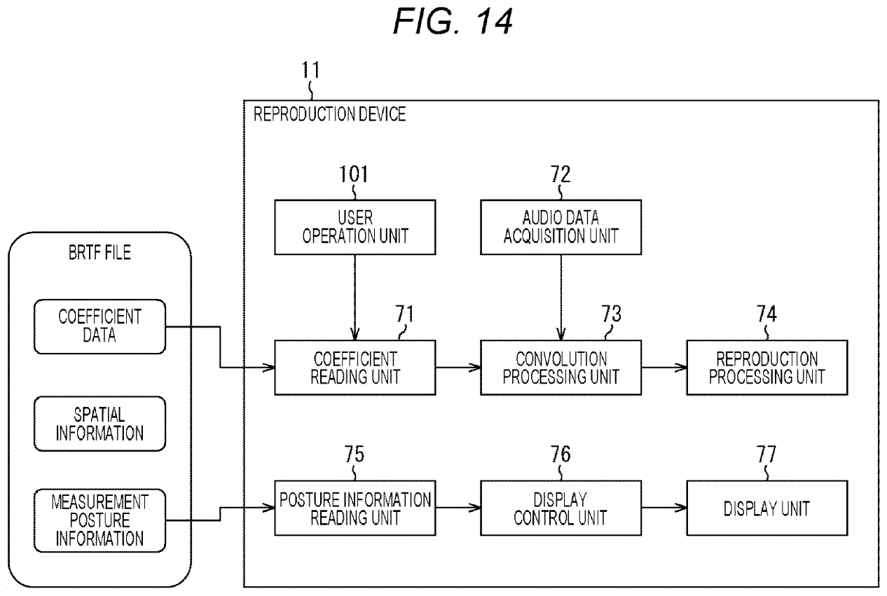

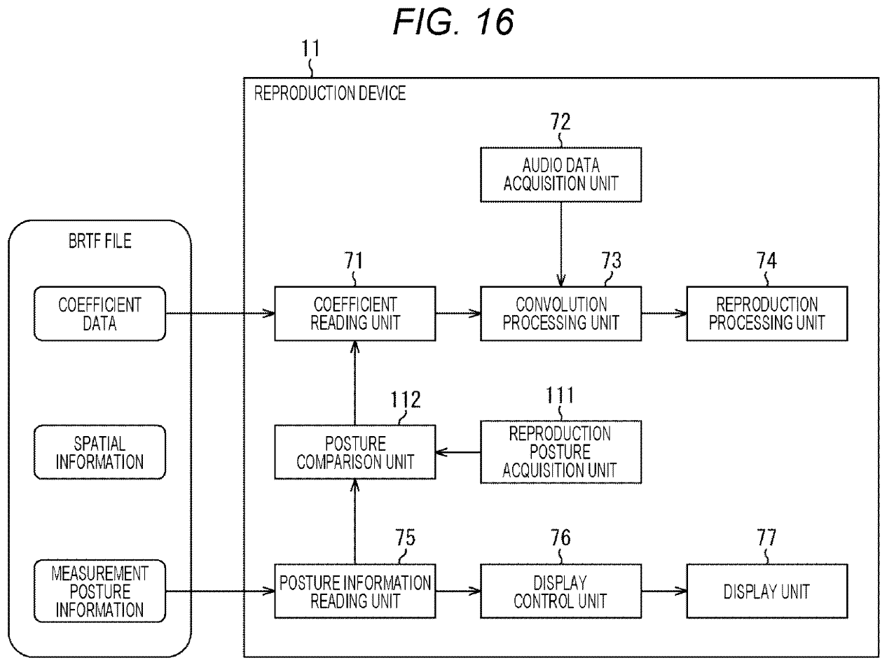

FIG. 14 is a block diagram illustrating a functional configuration example of the reproduction device 11. In FIG. 14, the same components as the components described with reference to FIG. 9 are denoted by the same reference signs. The overlapping description will be omitted as appropriate. The same applies to FIGS. 16, 19, and 23 to be described later.

The configuration of the reproduction device 11 illustrated in FIG. 14 is different from the configuration of the reproduction device 11 of FIG. 9 in that a user operation unit 101 is provided.

The posture information reading unit 75 reads a plurality of pieces of the measurement posture information from the BRTF file and supplies the measurement posture information to the display control unit 76.

The display control unit 76 draws a plurality of the measurement postures of the measurement subject on the basis of a plurality of pieces of the measurement posture information supplied from the posture information reading unit 75, and causes the display unit 77 to display the measurement postures.

The display unit 77 displays a plurality of the measurement postures under the control of the display control unit 76.

The user operation unit 101 receives an input of an operation of selecting the measurement posture.

The coefficient reading unit 71 reads coefficient data associated with the measurement posture selected by the producer from the BRTF file according to the operation of which the input is received by the user operation unit 101.

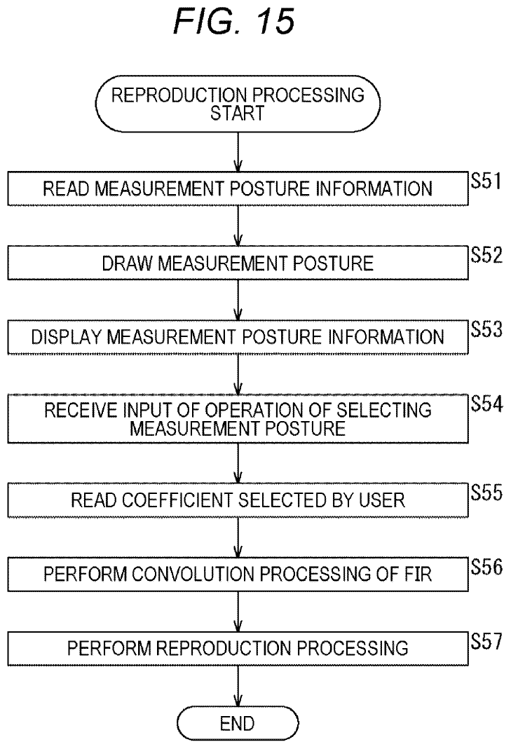

The reproduction processing of the reproduction device 11 having the above-described configuration will be described with reference to a flowchart of FIG. 15.

In step S51, the posture information reading unit 75 reads a plurality of pieces of the measurement posture information from the BRTF file.

In step S52, the display control unit 76 draws the measurement posture on the basis of the measurement posture information.

In step S53, the display control unit 76 causes the display unit 77 to displays a plurality of the measurement postures.

In step S54, the user operation unit 101 receives an input of an operation of selecting the measurement posture.

In step S55, the coefficient reading unit 71 reads coefficient data associated with the measurement posture selected by the producer as a user from the BRTF file according to the operation of which the input is received by the user operation unit 101.

Processing of steps S56 and S57 are similar to the processing of step S22 and S23 of FIG. 11.

As described above, for example, a plurality of the measurement postures may be presented to the producer such that the producer can select a measurement posture similar to own posture. Since the reproduction is performed using the BRTF measurement data associated with the measurement posture similar to the posture of the producer at the time of reproduction, it is possible to improve the reproduction accuracy of the sound in the measurement environment perceived by the producer.

### Example in which Measurement Posture is Automatically Selected

In the reproduction environment, the reproduction may be performed using the BRTF measurement data associated with the measurement posture similar to the posture of the producer.

FIG. 16 is a block diagram illustrating a functional configuration example of the reproduction device 11.

The configuration of the reproduction device 11 illustrated in FIG. 16 is different from the configuration of the reproduction device 11 in FIG. 9 in that a reproduction posture acquisition unit 111 and a posture comparison unit 112 are provided.

The posture information reading unit 75 reads a plurality of pieces of the measurement posture information from the BRTF file and supplies the measurement posture information to the display control unit 76 and the posture comparison unit 112.

For example, the reproduction posture acquisition unit 111 acquires posture information indicating the posture of the producer at the time of reproduction on the basis of a detection result of the posture sensor such as an IMU attached to the producer, and supplies the posture information to the posture comparison unit 112. The posture information at the time of reproduction may be acquired by measurement using a device such as a head-mounted display capable of acquiring the posture of a wearer, measurement using the microphone, image processing, optical measurement using a marker, or the like.

The posture comparison unit 112 compares each of a plurality of pieces of the measurement posture information supplied from the posture information reading unit 75 with the posture information at the time of reproduction, which is supplied from the reproduction posture acquisition unit 111, and selects the measurement posture most similar to the posture at the time of reproduction.

The coefficient reading unit 71 reads coefficient data associated with the measurement posture selected by the posture comparison unit 112 from the BRTF file.

Note that, for example, the measurement posture information corresponding to the measurement posture selected by the posture comparison unit 112 may be displayed on the display unit 77.

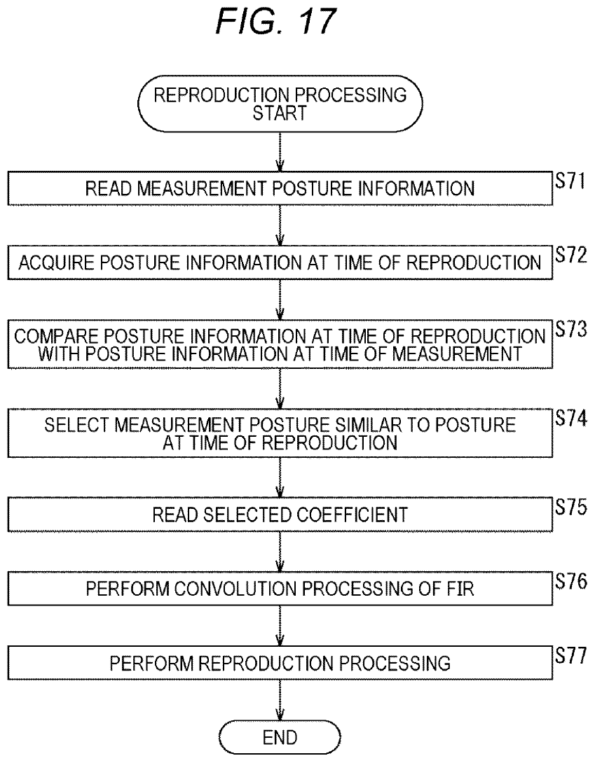

The reproduction processing performed by the reproduction device 11 having the above-described configuration will be described with reference to a flowchart of FIG. 17.

In step S71, the posture information reading unit 75 reads a plurality of pieces of the measurement posture information from the BRTF file.

In step S72, the reproduction posture acquisition unit 111 acquires the posture information indicating the posture of the producer at the time of reproduction.

In step S73, the posture comparison unit 112 compares each of a plurality of pieces of the measurement posture information with the posture information at the time of reproduction.

In step S74, the posture comparison unit 112 selects the measurement posture similar to the posture at the time of reproduction from among a plurality of the measurement postures.

In step S75, the coefficient reading unit 71 reads coefficient data associated with the measurement posture selected by the posture comparison unit 112 from the BRTF file.

Processing of steps S76 and S77 are similar to the processing of step S22 and S23 of FIG. 11.

As described above, the reproduction device 11 can select the measurement posture similar to the posture of the producer at the time of reproduction. Since the reproduction is performed using the BRTF measurement data associated with the measurement posture similar to the posture of the producer at the time of reproduction, it is possible to improve the reproduction accuracy of the sound in the measurement environment perceived by the producer.

### Example in which Comparison Result Between Posture at Time of Reproduction and Measurement Posture is Presented

The comparison result between the posture at the time of reproduction and the measurement posture may be presented to the producer.

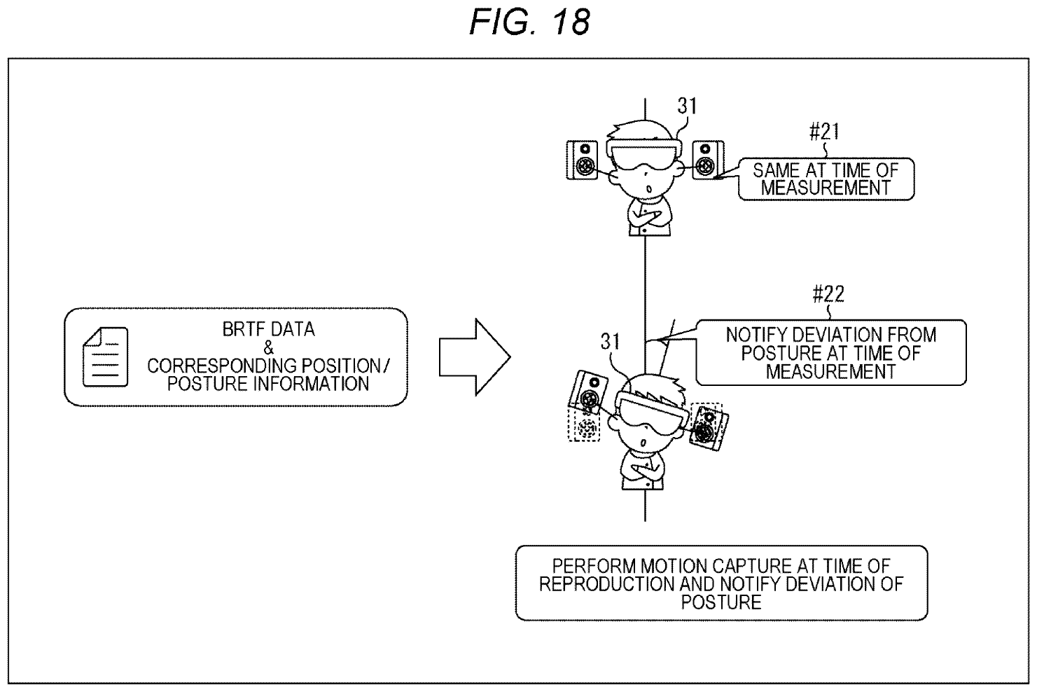

FIG. 18 is a diagram illustrating a flow of display of the comparison result between the posture at the time of reproduction and the measurement posture.

In the reproduction environment, the posture of the producer at the time of reproduction is acquired by motion capture or the like, and the producer is notified of a comparison result between the posture at the time of reproduction and the measurement posture indicated by the measurement posture information read from the BRTF file.

As illustrated in balloon #21, in a case where the posture at the time of reproduction matches the measurement posture, the producer is notified that the posture at the time of reproduction matches the measurement posture.

As illustrated in balloon #22, in a case where the posture at the time of reproduction is different from the measurement posture, the producer is notified of a deviation between the posture at the time of reproduction and the measurement posture. For example, comparison information such as a numerical value, a meter, and an image indicating the difference between the Euler angles of the head is displayed on a head-mounted display 31 mounted on the head of the producer.

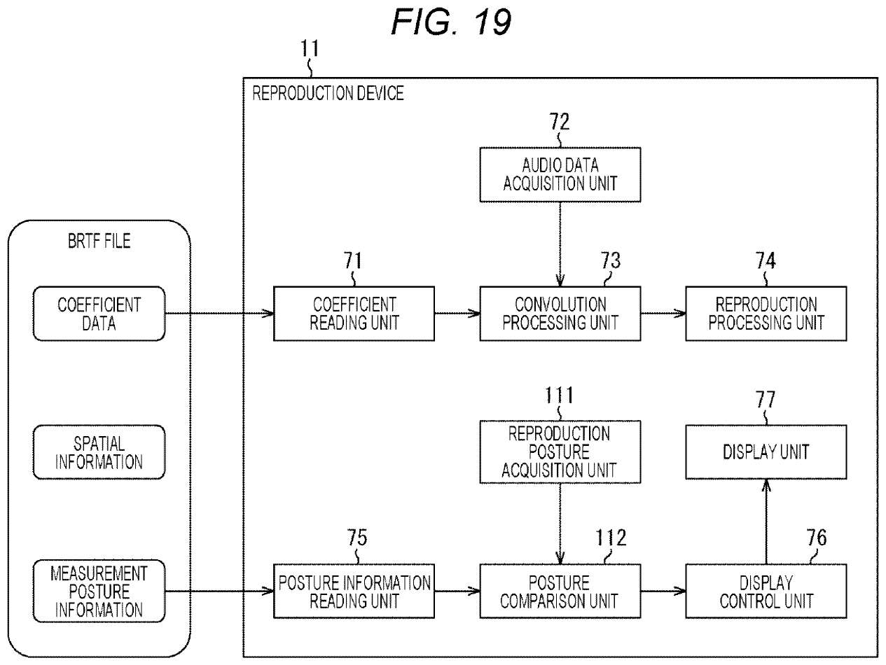

FIG. 19 is a block diagram illustrating a functional configuration example of the reproduction device 11.

The configuration of the reproduction device 11 illustrated in FIG. 19 is different from the configuration of the reproduction device 11 in FIG. 9 in that a reproduction posture acquisition unit 111 and a posture comparison unit 112 are provided.

The posture information reading unit 75 reads the measurement posture information from the BRTF file and supplies the measurement posture information to the posture comparison unit 112.

For example, the reproduction posture acquisition unit 111 acquires the posture information indicating the posture of the producer at the time of reproduction on the basis of the detection result of the posture sensor provided on the head-mounted display 31, and supplies the posture information to the posture comparison unit 112.

The posture comparison unit 112 supplies, to the display control unit 76, the comparison information obtained by comparing the measurement posture information supplied from the posture information reading unit 75 with the posture information at the time of reproduction, which is supplied from the reproduction posture acquisition unit 111.

The display control unit 76 causes the display unit 77 to display the comparison information supplied from the posture comparison unit 112. Furthermore, the display control unit 76 draws the posture at the time of reproduction and the measurement posture on the basis of the posture information at the time of reproduction and the measurement posture information, and causes the display unit 77 to displays both postures.

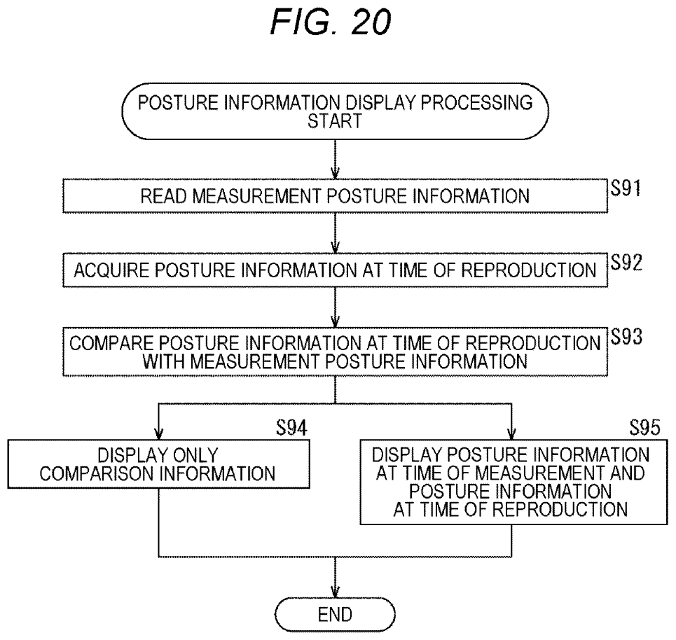

The posture information display processing performed by the reproduction device 11 having the above-described configuration will be described with reference to a flowchart of FIG. 20. For example, the posture information display processing of FIG. 20 is performed in parallel with the reproduction processing of FIG. 11.

In step S91, the posture information reading unit 75 reads the measurement posture information from the BRTF file.

In step S92, the reproduction posture acquisition unit 111 acquires the posture information indicating the posture of the producer at the time of reproduction.

In step S93, the posture comparison unit 112 compares the posture information at the time of reproduction with the measurement posture information to acquire comparison information. After the processing of step S93, the display control unit 76 performs processing of step S94 or step S95.

In step S94, the display control unit 76 causes the display unit 77 to displays the comparison information.

On the other hand, in step S95, the display control unit 76 causes the display unit 77 to displays the measurement posture information and the posture information at the time of reproduction.

After the processing in step S94 or step S95, the posture information display processing is ended. Note that the display of the comparison information in step S94 and the display of the measurement posture information and the posture information at the time of reproduction in step S95 may be performed simultaneously.

As described above, the producer can confirm the deviation between the posture of the measurement subject at the time of the BRTF measurement and the own posture. when the producer takes the posture at the time of reproduction so as to match the posture of the measurement subject at the time of the measurement, it is possible to improve the reproduction accuracy of the sound in the measurement environment perceived by the producer.

### Example in which Spatial Information is Displayed

Spatial information that is information indicating the shape of the measurement space, the position of the measurement sound source, the measurement position, and the like may be displayed on the display unit 77.

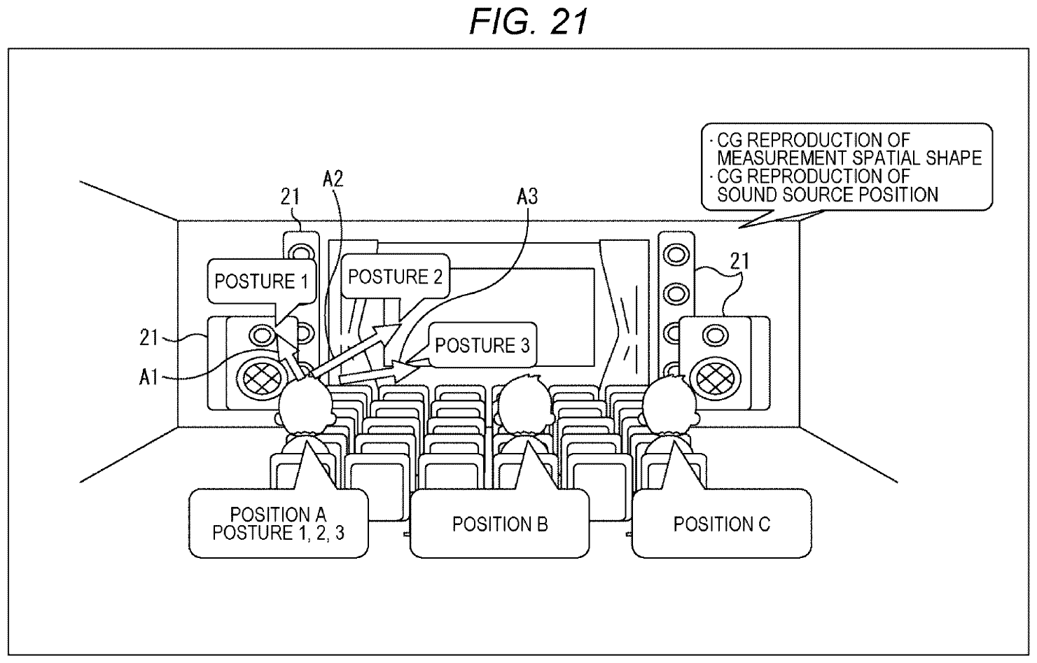

FIG. 21 is a diagram illustrating an example of a display screen of the spatial information.

As illustrated in FIG. 21, on the display screen, the shape of the movie theater as the measurement space and the speaker 21 as the measurement sound source are reproduced using CG.

In the measurement environment, in a case where the BRTF measurement is performed in a state in which the measurement subjects sit on the seats at the positions A to C, respectively, an image indicating the measurement subjects sitting at the positions A to C is displayed on the selection screen. Furthermore, the measurement postures are indicated by displaying arrows A1 to A3. Note that the balloon in the drawing is illustrated for convenience of description, and is not actually displayed.

As described above, in the reproduction environment, the screen of the overhead view of the measurement position is displayed on the display unit 77 as the spatial information. The producer can visually recognize the size and shape of the movie theater as the measurement space, the position of the measurement sound source, the measurement position, and the like. Instead of the overhead view of the measurement position, a screen in the field of view of the measurement subject at the measurement position may be displayed on the display unit 77.

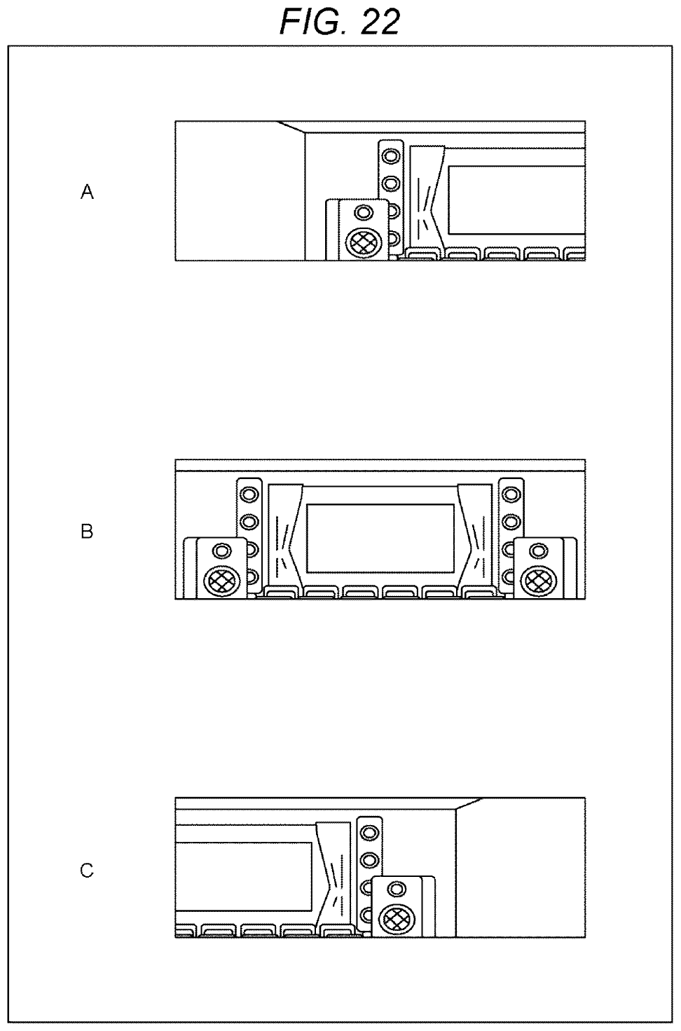

FIG. 22 is a diagram illustrating an example of a screen in the field of view of the measurement subject.

A of FIG. 22 illustrates a field of view of the measurement subject sitting on the seat at the position A in the posture 1, and B of FIG. 22 illustrates a field of view of the measurement subject sitting on the seat at the position A in the posture 2. C of FIG. 22 illustrates a field of view of the measurement subject sitting on the seat at the position A in the posture 3.

As described above, in the reproduction environment, the screen in the field of view of the measurement subject at the measurement position is displayed on the display unit 77 as the spatial information. The producer can visually recognize a field of view centered on the direction of the line-of-sight of the measurement subject at the time of measurement. Note that both the screen in the overhead view of the measurement position and the screen in the field of view of the measurement subject at the measurement position may be displayed on the display unit 77.

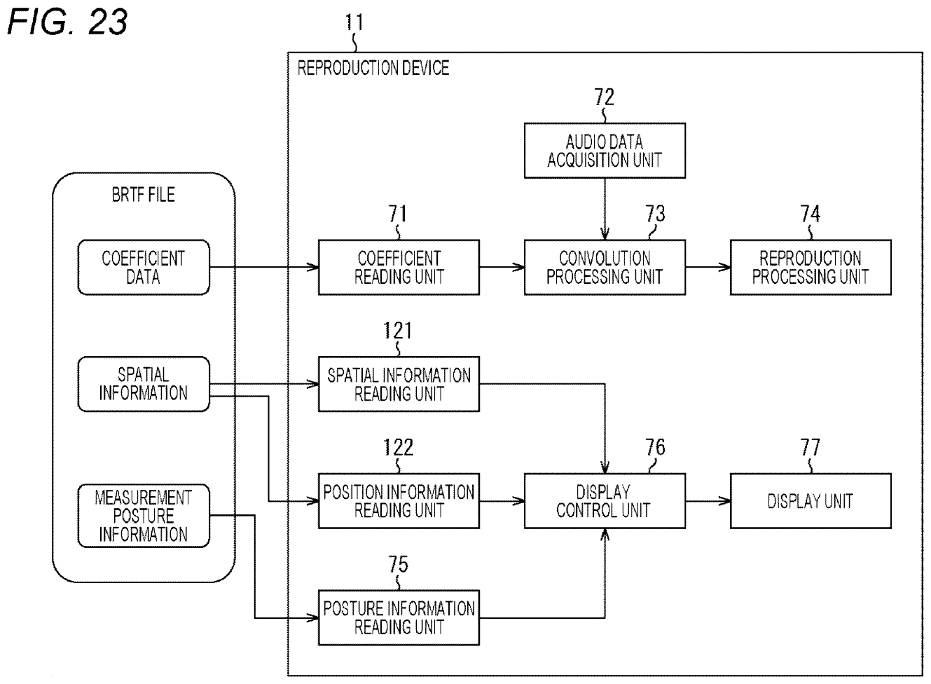

FIG. 23 is a block diagram illustrating a functional configuration example of the reproduction device 11.

The configuration of the reproduction device 11 illustrated in FIG. 23 is different from the configuration of the reproduction device 11 in FIG. 9 in that a spatial information reading unit 121 and a position information reading unit 122 are provided.

The spatial shape data, the position information of the measurement sound source, and the measurement position information are stored as spatial information in the BRTF file.

The spatial information reading unit 121 reads the spatial shape data and the position information of the measurement sound source from the BRTF file, and supplies the spatial shape data and the position information of the measurement sound source to the display control unit 76.

The position information reading unit 122 reads the measurement position information from the BRTF file and supplies the measurement position information to the display control unit 76.

The display control unit 76 draws the measurement space by using the CG on the basis of the spatial shape data, and draws the speaker 21 by using the CG on the basis of the position information of the measurement sound source. Furthermore, the display control unit 76 draws the measurement position in the measurement space on the basis of the measurement position information, and causes the display unit 77 to display the screen in the overhead view of the measurement position. Note that the measurement space, the measurement sound source, the measurement position, and the like may be drawn using a simplified figure, a three-dimensional display CG, or the like.

The display control unit 76 causes the display unit 77 to display the screen in the field of view of the measurement subject at the measurement position by using the CG of the measurement space and measurement sound source on the basis of the measurement posture information.

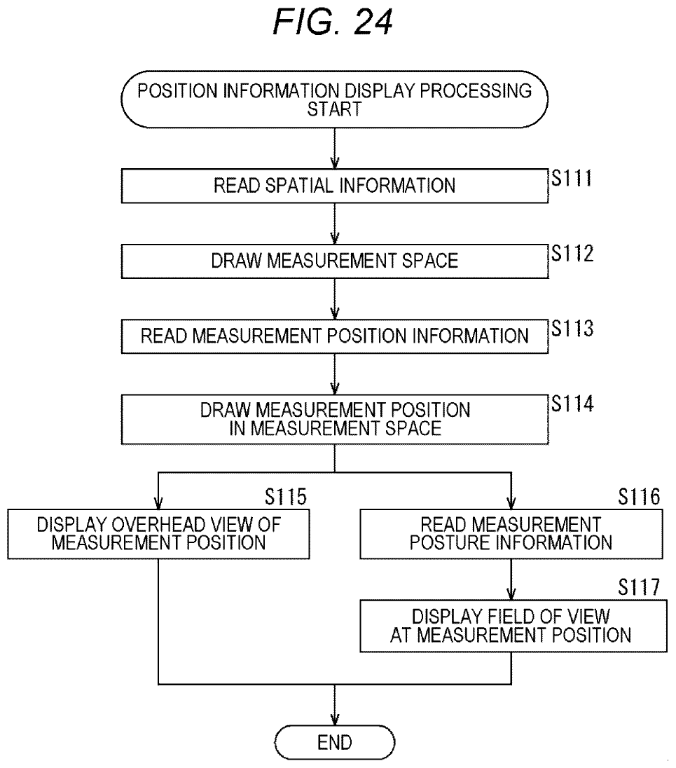

The position information display processing performed by the reproduction device 11 having the above-described configuration will be described with reference to a flowchart of FIG. 24. For example, the position information display processing of FIG. 24 is performed in parallel with the reproduction processing of FIG. 11.

In step S111, the spatial information reading unit 121 reads the spatial shape data and the position information of the measurement sound source as the spatial information from the BRTF file.

In step S112, the display control unit 76 draws the measurement space including the speaker 21 by using the CG on the basis of the spatial shape data and the position information of the measurement sound source.

In step S113, the position information reading unit 122 reads the measurement position information from the BRTF file.

In step S114, the display control unit 76 draws the measurement position in the measurement space. After the processing in step S114, processing in step S115 or a series of processing in steps S116 and S117 is performed.

In step S115, the display control unit 76 causes the display unit 77 to displays the screen in the overhead view of the measurement position.

On the other hand, in step S116, the posture information reading unit 75 reads the measurement posture information.

In step S117, the display control unit 76 causes the display unit 77 to display the screen in the field of view of the measurement subject at the measurement position by using the CG of the measurement space and measurement sound source on the basis of the measurement posture information.

After the processing in step S115 or step S117, the position information display processing is ended.

As described above, the producer can visually recognize what kind of measurement environment is reproduced by viewing the screen of the position of the measurement subject of at the time of BRTF measurement and the screen in the field of view from the position.

### <Example of Selecting Measurement Position>

As described with reference to FIG. 21, a plurality of the measurement positions may be presented to the producer such that the producer can select a desired measurement position.

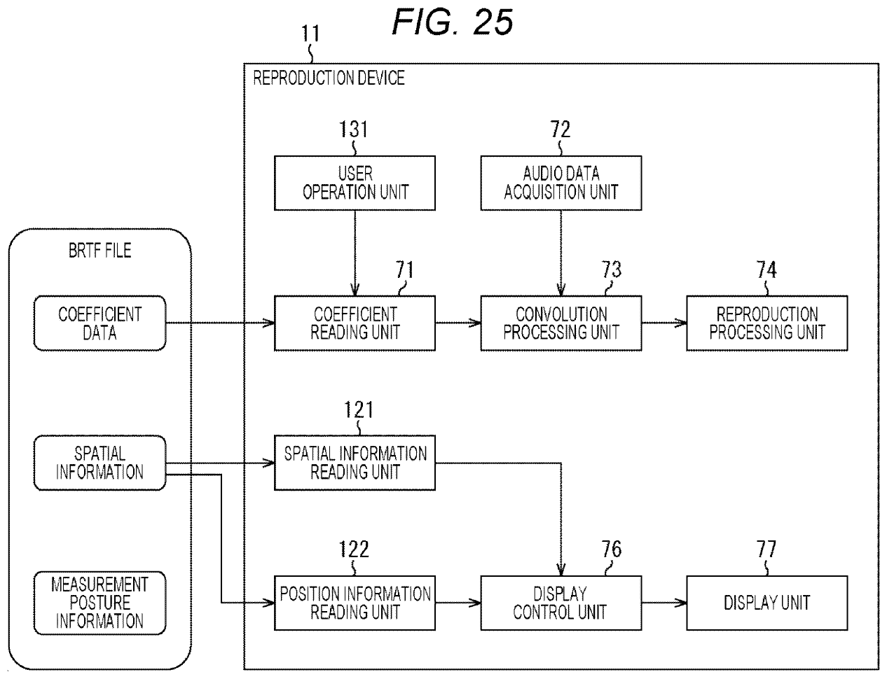

FIG. 25 is a block diagram illustrating a functional configuration example of the reproduction device 11. In FIG. 25, the same components as the components described with reference to FIG. 23 are denoted by the same reference signs. The overlapping description will be omitted as appropriate.

The configuration of the reproduction device 11 illustrated in FIG. 25 is different from the configuration of the reproduction device 11 in FIG. 23 in that a user operation unit 131 is provided but the posture information reading unit 75 is not provided.

The position information reading unit 122 reads a plurality of pieces of the measurement position information from the BRTF file and supplies the measurement position information to the display control unit 76.

The display control unit 76 draws the measurement positions in the measurement space on the basis of a plurality of pieces of the measurement position information, and causes the display unit 77 to display the screen in the overhead view of the measurement position.

The user operation unit 131 receives an input of an operation of selecting the measurement position.

The coefficient reading unit 71 reads coefficient data associated with the measurement position selected by the producer from the BRTF file according to the operation of which the input is received by the user operation unit 131.

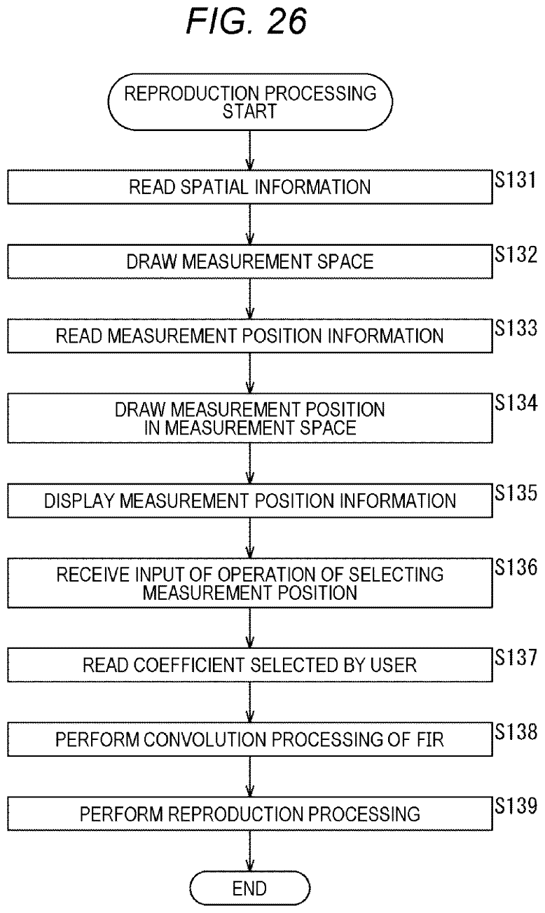

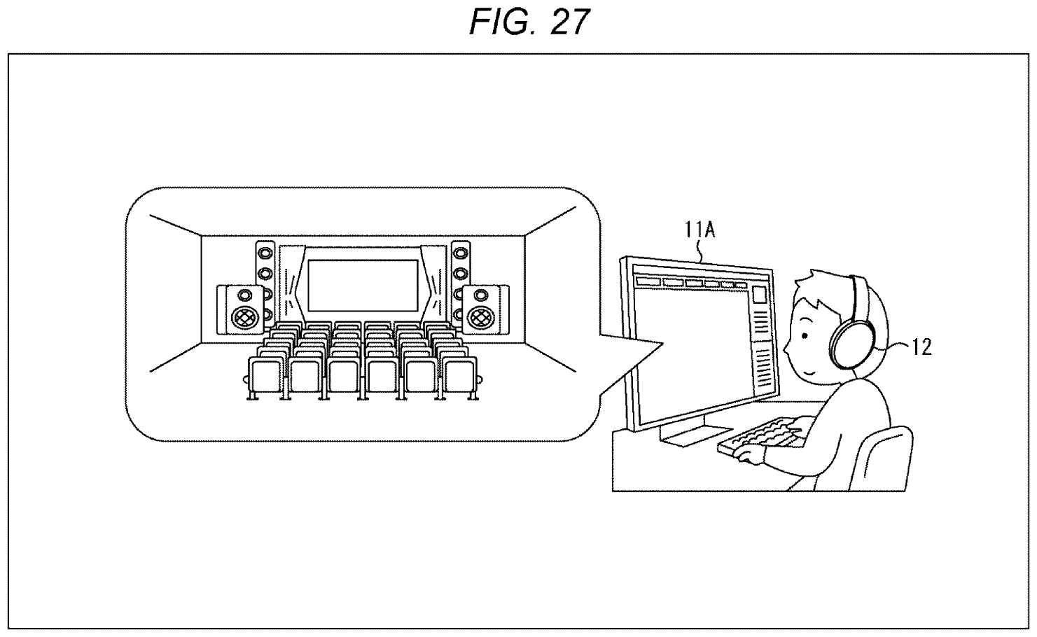

The reproduction processing performed by the reproduction device 11 having the above-described configuration will be described with reference to a flowchart of FIG. 26.

Processing of steps S131 and S132 are similar to the processing of step S111 and S112 of FIG. 23.

In step S133, the position information reading unit 122 reads a plurality of pieces of the measurement position information.

In step S134, the display control unit 76 draws the measurement positions in the measurement space on the basis of a plurality of pieces of the measurement position information.

In step S135, the display control unit 76 causes the display unit 77 to display a plurality of the measurement positions. For example, the overhead view of the measurement position is displayed on the display unit 77.

In step S136, the user operation unit 131 receives an input of an operation of selecting the measurement position.

In step S137, the coefficient reading unit 71 reads coefficient data associated with the measurement position selected by the producer as a user from the BRTF file according to the operation of which the input is received by the user operation unit 131.

Processing of steps S138 and S139 are similar to the processing of step S22 and S23 of FIG. 11.

As described above, a plurality of the measurement positions is presented to the producer, and the producer can select a measurement position to be reproduced using the BRTF.

### Example in which Reverberation Amount is Adjusted According to Reproduction Environment

The reverberation amount of BRIR may be adjusted according to the size of the display unit 77 provided in the reproduction environment.

FIG. 27 is a diagram illustrating an example of the reproduction environment.

As illustrated in a balloon of FIG. 27, the movie theater image as the measurement space is displayed on the display 11A provided in the reproduction environment. A movie is displayed on the screen of the movie theater. The producer can confirm how the movie is displayed on the screen of the movie theater.

In a case where the screen size of the display 11A is small, when the reverberation generated in the movie theater is reproduced as it is, there may be a case where there is a sense of discomfort that the reverberation amount of the sound output from the headphones 12 is greater than the reverberation amount expected on the basis of the size of the movie theater displayed on the display 11A.

In order to prevent this sense of discomfort, the reproduction device 11 adjusts the reverberation amount of the BRIR according to the size of the display device such as the display 11A. For example, in a case where a small display device is used and the BRIR measured in a wide measurement environment is used, the reproduction device 11 performs signal processing so as to reduce the reverberation amount. Instead of performing the signal processing to adjust the reverberation amount, the reproduction device 11 may notify the producer of recommendation to perform the signal processing.

Note that, instead of displaying the movie theater image, a screen image on which a moving image of a movie corresponding to the sound of the movie is displayed may be displayed on the display 11A.

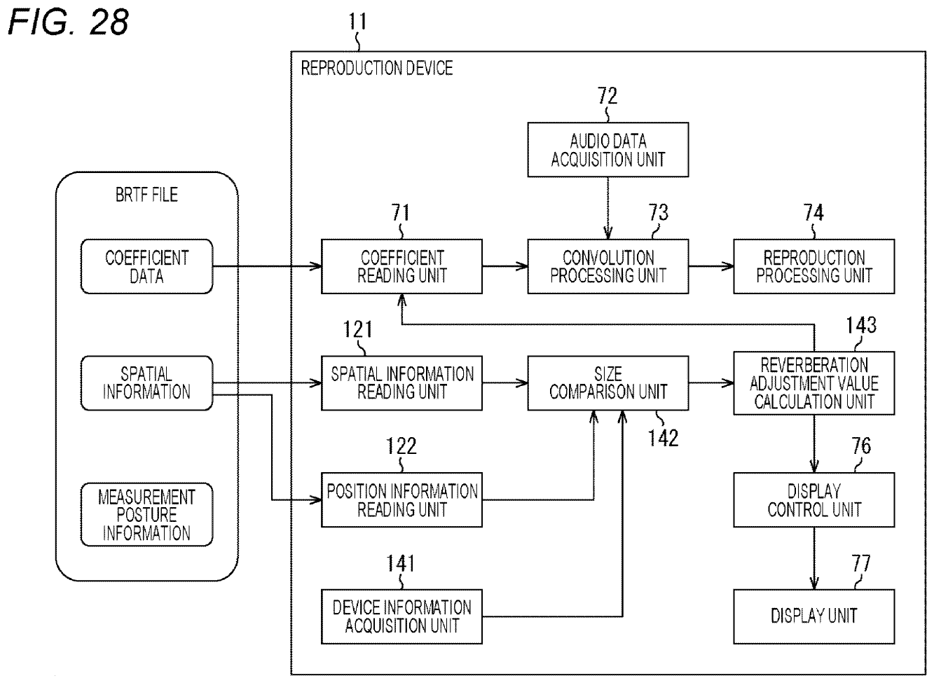

FIG. 28 is a block diagram illustrating a functional configuration example of the reproduction device 11. In FIG. 28, the same components as the components described with reference to FIG. 23 are denoted by the same reference signs. The overlapping description will be omitted as appropriate.

The configuration of the reproduction device 11 illustrated in FIG. 28 is different from the configuration of the reproduction device 11 in FIG. 23 in that a device information acquisition unit 141, a size comparison unit 142, and a reverberation adjustment value calculation unit 143 are provided.

The device information acquisition unit 141 acquires device information indicating the size of the display device such as the display 11A, and supplies the device information to the size comparison unit 142.

In a case where the movie theater image is displayed on the display unit 77, the size comparison unit 142 compares the size of the display device indicated by the device information acquired by the device information acquisition unit 141 with the size of the measurement space indicated by the spatial shape data read by the spatial information reading unit 121. The size comparison unit 142 supplies a comparison result between the size of the display device and the size of the measurement space to the reverberation adjustment value calculation unit 143.

In a case where the screen image on which the movie is displayed is displayed on the display unit 77, the size comparison unit 142 acquires the size of the screen as viewed from the measurement position on the basis of the spatial shape data and the measurement position information supplied from the position information reading unit 122. The size comparison unit 142 compares the size of the display device with the size of the screen and supplies the comparison result to the reverberation adjustment value calculation unit 143.

The reverberation adjustment value calculation unit 143 calculates a reverberation adjustment value indicating an adjustment amount of reverberation according to the comparison result obtained by the size comparison unit 142. The reverberation adjustment value calculation unit 143 causes the coefficient reading unit 71 to perform signal processing of applying the reverberation adjustment value to the coefficient data. Furthermore, the reverberation adjustment value calculation unit 143 supplies the reverberation adjustment value to the display control unit 76.

The display control unit 76 causes the display unit 77 to display a screen with contents for recommending performing signal processing for adjusting the reverberation amount according to the reverberation adjustment value supplied from the reverberation adjustment value calculation unit 143.

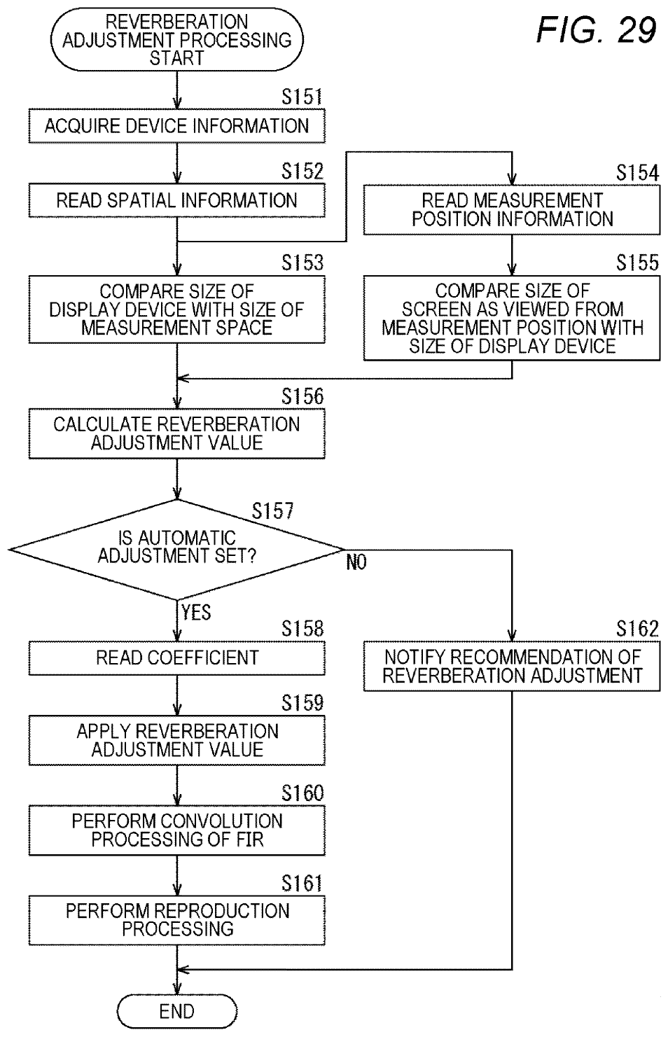

The reverberation adjustment processing performed by the reproduction device 11 having the above-described configuration will be described with reference to a flowchart of FIG. 29.

In step S151, the device information acquisition unit 141 acquires the device information.

In step S152, the spatial information reading unit 121 reads the spatial shape data as spatial information from the BRTF file. For example, in a case where the movie theater image is displayed on the display unit 77, processing of step S153 is performed after step S152.

In step S153, the size comparison unit 142 compares the size of the display device indicated by the device information with the size of the measurement space indicated by the spatial shape data.

On the other hand, for example, in a case where the screen image on which the movie is displayed is displayed on the display unit 77, a series of processing of step S154 and step S155 is performed after step S152.

In step S154, the position information reading unit 122 reads the measurement position information from the BRTF file.

In step S155, the size comparison unit 142 acquires the size of the screen as viewed from the measurement position on the basis of the spatial shape data and the measurement position information, and compares the size of the screen with the size of the display device.

After the processing of step S153 or step S155 is performed, the processing of step S156 is performed.

In step S156, the reverberation adjustment value calculation unit 143 calculates the reverberation adjustment value on the basis of the comparison result obtained by the size comparison unit 142.

In step S157, the reverberation adjustment value calculation unit 143 determines whether or not automatic adjustment of the reverberation amount is set to be enabled. For example, setting of enabling or disabling the automatic adjustment of the reverberation amount is performed in advance by the producer.

In a case where it is determined in step S157 that the automatic adjustment is set to be enabled, the coefficient reading unit 71 reads the coefficient data from the BRTF file in step S158.

In step S159, the coefficient reading unit 71 performs signal processing of applying the reverberation adjustment value on the coefficient data.

Processing of steps S160 and S161 are similar to the processing of step S22 and S23 of FIG. 11.

On the other hand, in a case where it is determined in step S157 that the automatic adjustment is set to be disabled, in step S162, the display control unit 76 causes the display unit 77 to display a screen with contents for recommending performing signal processing for adjusting the reverberation amount, and notify the recommendation of the reverberation adjustment.

After the processing in step S161 or step S162, the reverberation adjustment processing in FIG. 29 is ended. Note that processing of performing display based on the condition information, such as the posture information display processing in FIG. 12, may be performed in parallel with the reverberation adjustment processing.

As described above, in the reproduction device 11, the reverberation amount is adjusted according to the size of the display device. Therefore, it is possible to prevent or reduce the sense of discomfort caused by the difference between the reverberation amount expected on the basis of the size of the movie theater or screen displayed on the display device and the reverberation amount reproduced by the sound output from the headphones 12.

### Example in which Panning is Performed

The sound image of the sound output from a plurality of speakers according to the sound signal subjected to panning processing such as vector base amplitude panning (VBAP) based on the position information of a virtual sound source included in the object audio data is localized at the position of the virtual sound source.

The sound output from the measurement sound source in the measurement space may be reproduced according to the sound signal subjected to the panning processing with the sound output from the headphones 12.

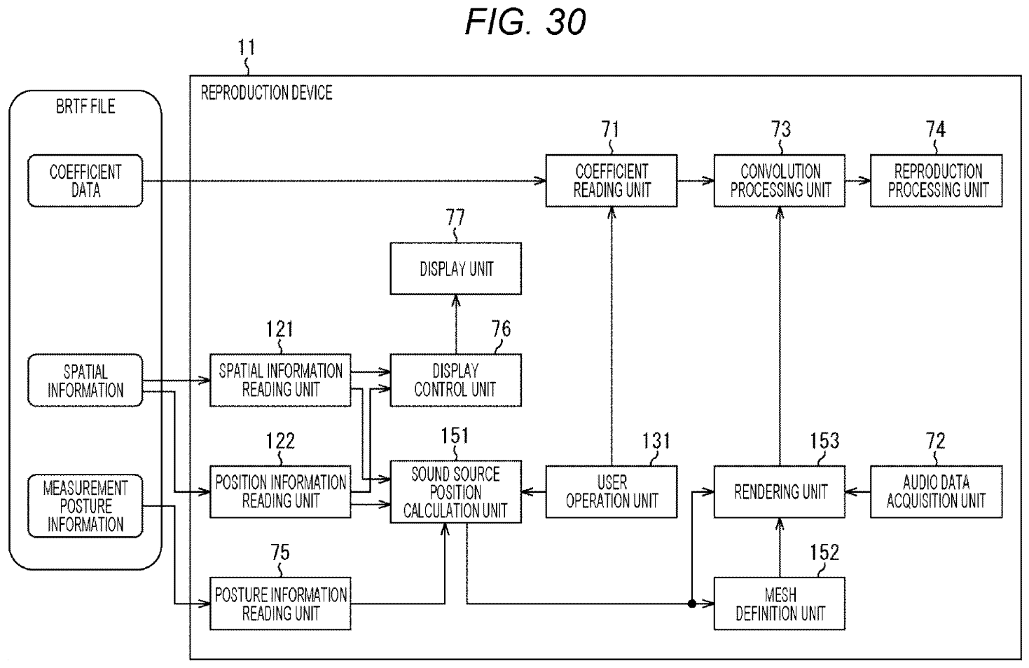

FIG. 30 is a block diagram illustrating a functional configuration example of the reproduction device 11. In FIG. 30, the same components as the components described with reference to FIG. 25 are denoted by the same reference signs. The overlapping description will be omitted as appropriate.

The configuration of the reproduction device 11 illustrated in FIG. 30 is different from the configuration of the reproduction device 11 in FIG. 25 in that a sound source position calculation unit 151, a mesh definition unit 152, and a rendering unit 153 are provided.

The audio data acquisition unit 72 acquires object audio data and supplies the object audio data to the rendering unit 153.

The sound source position calculation unit 151 acquires the measurement position information indicating the measurement position selected by the producer via the position information reading unit 122 according to the operation of which the input is received by the user operation unit 131. The sound source position calculation unit 151 calculates coordinates of the position of the speaker 21 as viewed from the measurement position selected by the producer on the basis of the spatial shape data and the position information of the measurement sound source, which are supplied from the spatial information reading unit 121, and the measurement position information.

The sound source position calculation unit 151 acquires the measurement posture information associated with the measurement position selected by the producer via the posture information reading unit 75. The sound source position calculation unit 151 supplies the coordinates of the position of the speaker 21 around the measurement position, which are obtained by rotating the coordinates of the position of the speaker 21, to the mesh definition unit 152 and the rendering unit 153 on the basis of the measurement posture information.

The mesh definition unit 152 performs mesh definition processing for panning on the basis of the coordinates of the position of the speaker 21 supplied from the sound source position calculation unit 151. The mesh definition unit 152 supplies information indicating the defined mesh to the rendering unit 153.

The rendering unit 153 performs panning processing based on the coordinates of the position of the speaker 21 supplied from the sound source position calculation unit 151 and the information supplied by the mesh definition unit 152 on the sound signal included in the object audio data supplied from the audio data acquisition unit 72. The rendering unit 153 functions as a renderer for rendering the object audio. The rendering unit 153 supplies the sound signal obtained by performing the panning processing to the convolution processing unit 73.

The convolution processing unit 73 performs convolution processing using the coefficient data on the sound signal supplied from the rendering unit 153.

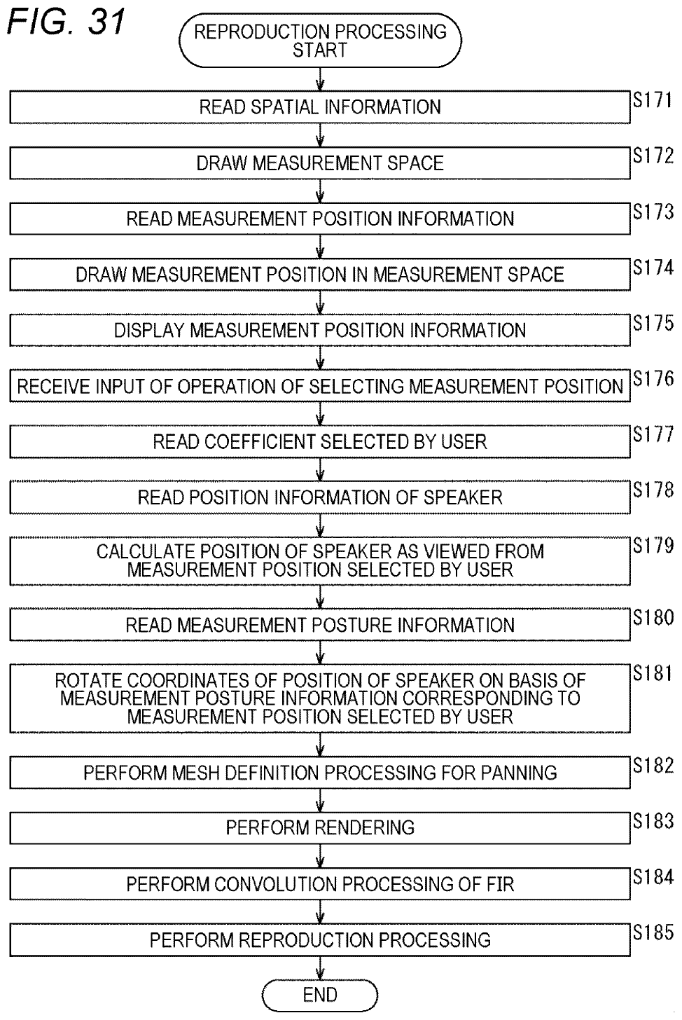

The reproduction processing performed by the reproduction device 11 having the above-described configuration will be described with reference to a flowchart of FIG. 31. For example, the reproduction processing of FIG. 31 is started in a state in which the object audio data is acquired in advance by the audio data acquisition unit 72.

Processing of steps S171 to S177 are similar to the processing of steps S131 to S137 in FIG. 25.

In step S178, the spatial information reading unit 121 reads the position information of the speaker 21 as the measurement sound source from the BRTF file.

In step S179, the sound source position calculation unit 151 calculates the position of the speaker 21 as viewed from the measurement position selected by the producer as the user on the basis of the spatial shape data, the position information of the speaker 21, and the measurement position information.

In step S180, the posture information reading unit 75 reads the measurement posture information associated with the measurement position selected by the measurement subject from the BRTF file.

In step S181, the sound source position calculation unit 151 acquires the coordinates of the position of the speaker 21 around the measurement position, which are obtained by rotating the coordinates of the position of the speaker 21, on the basis of the measurement posture information associated with the measurement position selected by the producer.

In step S182, the mesh definition unit 152 performs mesh definition processing for panning on the basis of the coordinates of the position of the speaker 21 around the measurement position.

In step S183, the rendering unit 153 performs rendering of performing panning processing based on the coordinates of the position of the speaker 21 and the mesh information defined in step S182 on the sound signal included in the object audio data.

In step S184, the convolution processing unit 73 performs convolution processing of the FIR filter on the rendered object audio data by using the coefficient data, and generates a reproduction signal.

In step S185, the reproduction processing unit 74 performs reproduction processing.

As described above, the reproduction device 11 can reproduce the sound output from the measurement sound source in the measurement space by reproducing the sound signal subjected to the panning processing.

### <Others>

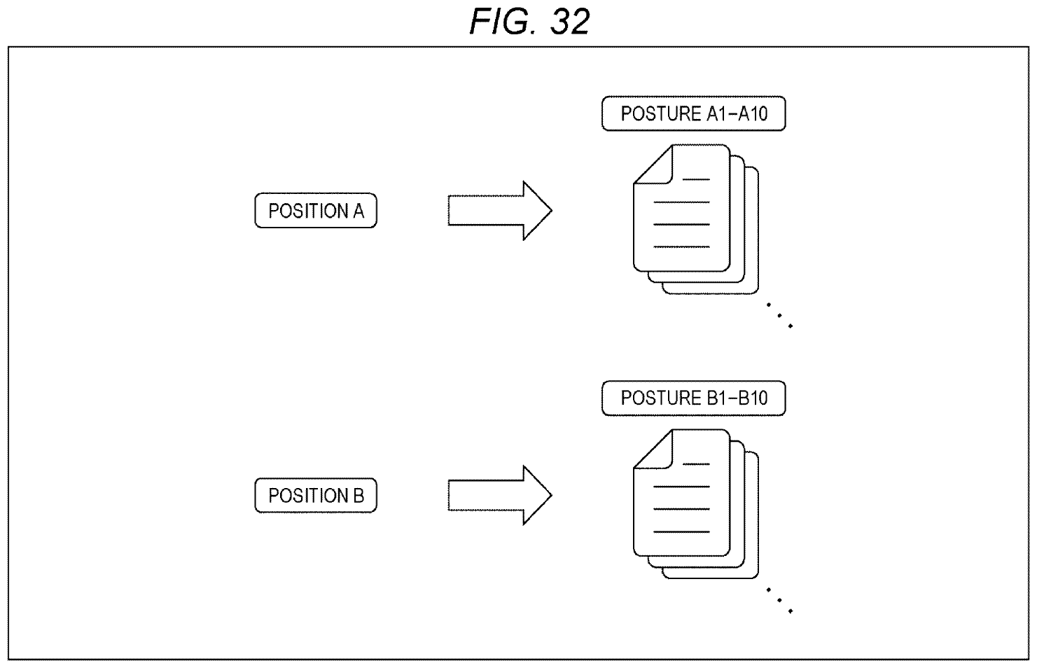

FIG. 32 is a diagram illustrating an example of a method of managing BRTF measurement data.

In a case where the BRTF measurement is performed at a plurality of the measurement positions in one measurement space, the measurement position information can be used to manage the BRTF measurement data.

For example, as illustrated in the upper side of FIG. 32, when the position A is selected, the BRTF measurement data measured in a state in which the measurement subject sits on the seat at the position A in the postures 1 to 10 is sorted. Furthermore, as illustrated in the lower side of FIG. 32, when the position B is selected, the BRTF measurement data measured in a state in which the measurement subject sits on the seat at the position B in the postures 1 to 10 is sorted.

In this manner, it is possible to use or manage the BRTF measurement data sorted for each measurement position.

### <Regarding Computer>

The above-described series of processing can be performed by hardware or can be performed by software. In a case where the series of processing is executed by software, a program included in the software is installed from a program recording medium to a computer incorporated in dedicated hardware, a general-purpose personal computer, or the like.

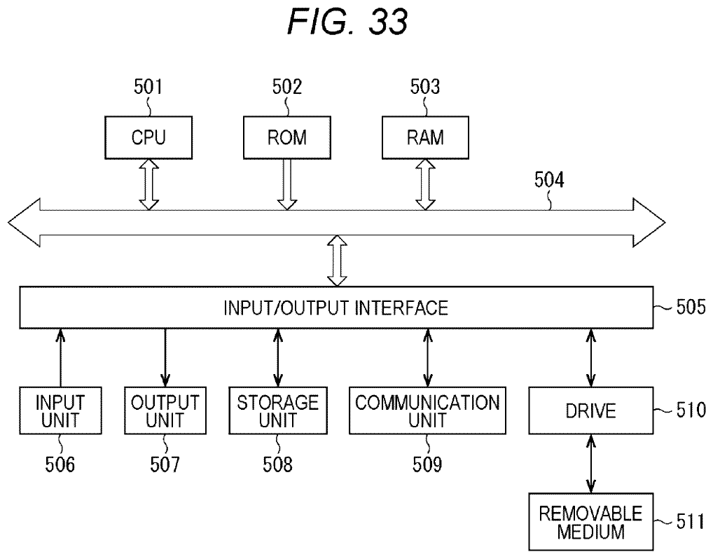

FIG. 33 is a block diagram illustrating a configuration example of hardware of a computer that executes the above-described series of processing by a program. The information processing device 1 and the reproduction device 11 include a PC having the same configuration as the configuration illustrated in FIG. 33.

A central processing unit (CPU) 501, a read only memory (ROM) 502, and a random access memory (RAM) 503 are mutually connected by a bus 504.

An input/output interface 505 is further connected to the bus 504. An input unit 506 including a keyboard and a mouse, and an output unit 507 including a display and a speaker are connected to the input/output interface 505. Furthermore, a storage unit 508 including a hard disk and a nonvolatile memory, a communication unit 509 including a network interface, and a drive 510 that drives a removable medium 511 are connected to the input/output interface 505.

In the computer configured as described above, for example, the CPU 501 loads a program stored in the storage unit 508 into the RAM 503 via the input/output interface 505 and the bus 504 and executes the program to perform the above-described series of processing.

For example, the program to be executed by the CPU 501 is stored in the removable medium 511, or provided via a wired or wireless transmission medium such as a local area network, the Internet, or digital broadcasting, and then installed in the storage unit 508.

The program executed by the computer may be a program in which the processing is performed in time series in the order described in the present description, or may be a program in which the processing is performed in parallel or at a necessary timing such as when a call is made.

Note that, in the present description, a system means an assembly of a plurality of components (devices, modules (parts), and the like), and it does not matter whether or not all the components are located in the same housing. Therefore, a plurality of devices housed in separate housings and connected to each other via a network and one device in which a plurality of modules is housed in one housing are both systems.

Note that, the effects described in the present specification are merely examples and are not limited, and there may be other effects.

An embodiment of the present technology is not limited to the above-described embodiment, and various modifications can be made without departing from the scope of the present technology.

For example, the present technology may be configured as cloud computing in which a function is shared by a plurality of devices via a network to process together.

Furthermore, each step described in the flowchart described above may be executed by one device, or may be executed in a shared manner by a plurality of devices.

Moreover, in a case where a plurality of processing steps is included in one step, a plurality of the processing included in one step can be performed by one device or shared and performed by a plurality of devices.

### Combination Example of Configurations

The present technology may also have the following configurations.

(1)

An information processing device including a generation unit configured to generate a transfer characteristic file storing measurement data of transfer characteristics of a sound according to acoustic characteristics of a measurement space and condition information indicating a condition at a time of measuring the transfer characteristics.

(2)

The information processing device according to (1), in which the condition information includes shape data indicating a shape of the measurement space.

(3)

The information processing device according to (1) or (2),
in which the condition information includes sound source position information indicating a position of a sound source in the measurement space, the sound source position information being used to measure the transfer characteristics.
   (4)

The information processing device according to any one of (1) to (3),
in which the condition information includes position information and posture information of a measurement subject at the time of measuring the transfer characteristics.
   (5)

The information processing device according to (4),
in which in the transfer characteristic file, the measurement data, the position information, and the posture information are stored for each combination of a position and a posture of the measurement subject.
   (6)

The information processing device according to (5),
in which the condition information includes at least one of shape data indicating a shape of the measurement space or sound source position information indicating a position of a sound source in the measurement space, the sound source position information being used for measurement of the transfer characteristics, and
in the transfer characteristic file, reference information of at least one of the shape data or the sound source position information is stored for each combination of the position and the posture of the measurement subject.
   (7)

The information processing device according to any one of (1) to (6),
in which the condition information includes device characteristic data indicating transfer characteristics measured on the basis of a sound output from an output device worn by a listener of a sound reproduced using the measurement data.
   (8)

An information processing device including:
a reproduction control unit configured to control reproduction of a sound by using measurement data acquired from a transfer characteristic file storing the measurement data of transfer characteristics of a sound according to acoustic characteristics of a measurement space and condition information indicating a condition at a time of measuring the transfer characteristics; and
a presentation control unit configured to control presentation of information according to the condition information acquired from the transfer characteristic file.
   (9)

The information processing device according to (8),
in which the presentation control unit presents a posture of a measurement subject at the time of measuring the transfer characteristics, the posture being included in the condition information.
   (10)

The information processing device according to (9),
in which the presentation control unit presents a direction of a line-of-sight of the measurement subject at the time of measuring the transfer characteristics as the posture of the measurement subject.
   (11)

The information processing device according to any one of (8) to (10),
in which in the transfer characteristic file, the measurement data is stored for each posture of the measurement subject at the time of measuring the transfer characteristics, the posture being included in the condition information.
   (12)

The information processing device according to (11),
in which the presentation control unit presents a plurality of the postures of the measurement subject, which is included in the condition information, and
the reproduction control unit reproduces a sound by using the measurement data associated with a posture selected by a listener of the sound to be reproduced among a plurality of the postures of the measurement subject, which is presented by the presentation control unit.
   (13)

The information processing device according to (11),
in which the reproduction control unit compares the posture of the measurement subject included in the condition information with the posture of a listener of a sound to be reproduced, and reproduces the sound by using the measurement data associated with the posture of the measurement subject most similar to the posture of the listener.
   (14)

The information processing device according to any one of (8) to (13),
in which the presentation control unit presents a result of comparison between a posture of a measurement subject at the time of measuring the transfer characteristics and a posture of a listener of a reproduced sound, the result being included in the condition information.
   (15)

The information processing device according to any one of (8) to (14),
in which in the transfer characteristic file, the measurement data is stored for each combination of a position and a posture of a measurement subject at the time of measuring the transfer characteristics.
   (16)

The information processing device according to (15),
in which the presentation control unit presents at least one of the position of the measurement subject in the measurement space at the time of measuring the transfer characteristics or a field of view of the measurement subject, on the basis of the condition information.
   (17)

The information processing device according to (16),
in which the presentation control unit presents a plurality of the positions of the measurement subject in the measurement space on the basis of the condition information, and
the reproduction control unit reproduces a sound by using the measurement data associated with a position selected by a listener of the sound to be reproduced among a plurality of the positions of the measurement subject, which is presented by the presentation control unit.
   (18)

The information processing device according to (17),
in which the reproduction control unit reproduces a sound corresponding to audio data subjected to panning processing based on a position of a virtual output device in the measurement space based on the position selected by the listener.
   (19)

The information processing device according to any one of (8) to (18),
in which the reproduction control unit adjusts a reverberation amount of a sound to be reproduced according to a size of a display device on which an image of the measurement space or an image corresponding to the sound to be reproduced is displayed.
   (20)

A data structure of a file including:
measurement data of sound transfer characteristics of a sound according to acoustic characteristics of a measurement space; and
condition information indicating a condition at a time of measuring the transfer characteristics, the information being used for presentation by an information processing device configured to reproduce a sound by using the measurement data.

### REFERENCE SIGNS LIST

1 Information processing device
11 Reproduction device
11A Display
12 Headphones
21 Speaker
22-1 to 22-3 Camera
31 Head-mounted display
51 Reproduction processing unit
52 Output control unit
53 Spatial shape data acquisition unit
54 Sound source position information acquisition unit
55 Position and posture acquisition unit
56 BRTF acquisition unit
57 Transfer characteristic data acquisition unit
58 BRTF file generation unit
71 Coefficient reading unit
72 Audio data acquisition unit
73 Convolution processing unit
74 Reproduction processing unit
75 Posture information reading unit
76 Display control unit
77 Display unit
101 User operation unit
111 Reproduction posture acquisition unit
112 Posture comparison unit
121 Spatial information reading unit
122 Position information reading unit
131 User operation unit
141 Device information acquisition unit
142 Size comparison unit
143 Reverberation adjustment value calculation unit
151 Sound source position calculation unit
152 Mesh definition unit
153 Rendering unit

1. An information processing device comprising a generation unit configured to generate a transfer characteristic file storing measurement data of transfer characteristics of a sound according to acoustic characteristics of a measurement space and condition information indicating a condition at a time of measuring the transfer characteristics.

2. The information processing device according to claim 1,
wherein the condition information includes shape data indicating a shape of the measurement space.

3. The information processing device according to claim 1,
wherein the condition information includes sound source position information indicating a position of a sound source in the measurement space, the sound source position information being used to measure the transfer characteristics.

4. The information processing device according to claim 1,
wherein the condition information includes position information and posture information of a measurement subject at the time of measuring the transfer characteristics.

5. The information processing device according to claim 4,
wherein in the transfer characteristic file, the measurement data, the position information, and the posture information are stored for each combination of a position and a posture of the measurement subject.

6. The information processing device according to claim 5,
wherein the condition information includes at least one of shape data indicating a shape of the measurement space or sound source position information indicating a position of a sound source in the measurement space, the sound source position information being used for measurement of the transfer characteristics, and
in the transfer characteristic file, reference information of at least one of the shape data or the sound source position information is stored for each combination of the position and the posture of the measurement subject.

7. The information processing device according to claim 1,
wherein the condition information includes device characteristic data indicating transfer characteristics measured on a basis of a sound output from an output device worn by a listener of a sound reproduced using the measurement data.

8. An information processing device comprising:
a reproduction control unit configured to control reproduction of a sound by using measurement data acquired from a transfer characteristic file storing the measurement data of transfer characteristics of a sound according to acoustic characteristics of a measurement space and condition information indicating a condition at a time of measuring the transfer characteristics; and
a presentation control unit configured to control presentation of information according to the condition information acquired from the transfer characteristic file.

9. The information processing device according to claim 8,
wherein the presentation control unit presents a posture of a measurement subject at the time of measuring the transfer characteristics, the posture being included in the condition information.

10. The information processing device according to claim 9,
wherein the presentation control unit presents a direction of a line-of-sight of the measurement subject at the time of measuring the transfer characteristics as the posture of the measurement subject.

11. The information processing device according to claim 8,
wherein in the transfer characteristic file, the measurement data is stored for each posture of the measurement subject at the time of measuring the transfer characteristics, the posture being included in the condition information.

12. The information processing device according to claim 11,
wherein the presentation control unit presents a plurality of the postures of the measurement subject, which is included in the condition information, and
the reproduction control unit reproduces a sound by using the measurement data associated with a posture selected by a listener of the sound to be reproduced among a plurality of the postures of the measurement subject, which is presented by the presentation control unit.

13. The information processing device according to claim 11,
wherein the reproduction control unit compares the posture of the measurement subject included in the condition information with the posture of a listener of a sound to be reproduced, and reproduces the sound by using the measurement data associated with the posture of the measurement subject most similar to the posture of the listener.

14. The information processing device according to claim 8,
wherein the presentation control unit presents a result of comparison between a posture of a measurement subject at the time of measuring the transfer characteristics and a posture of a listener of a reproduced sound, the result being included in the condition information.

15. The information processing device according to claim 8,
wherein in the transfer characteristic file, the measurement data is stored for each combination of a position and a posture of a measurement subject at the time of measuring the transfer characteristics.

16. The information processing device according to claim 15,
wherein the presentation control unit presents at least one of the position of the measurement subject in the measurement space at the time of measuring the transfer characteristics or a field of view of the measurement subject, on a basis of the condition information.

17. The information processing device according to claim 16,
wherein the presentation control unit presents a plurality of the positions of the measurement subject in the measurement space on a basis of the condition information, and
the reproduction control unit reproduces a sound by using the measurement data associated with a position selected by a listener of the sound to be reproduced among a plurality of the positions of the measurement subject, which is presented by the presentation control unit.

18. The information processing device according to claim 17,
wherein the reproduction control unit reproduces a sound corresponding to audio data subjected to panning processing based on a position of a virtual output device in the measurement space based on the position selected by the listener.

19. The information processing device according to claim 8,
wherein the reproduction control unit adjusts a reverberation amount of a sound to be reproduced according to a size of a display device on which an image of the measurement space or an image corresponding to the sound to be reproduced is displayed.

20. A data structure of a file comprising:
measurement data of sound transfer characteristics of a sound according to acoustic characteristics of a measurement space; and
condition information indicating a condition at a time of measuring the transfer characteristics, the information being used for presentation by an information processing device configured to reproduce a sound by using the measurement data.
